(19) United States
(12) Patent Application Publication
(10) Pub. No.: US 2026/0305592 A1
(43) Pub. Date: Oct. 8, 2026

(54) INSTRUMENTED HOOF TESTER

(71) Applicant: STEP ANALYSIS, LLC, Millersville, MD (US)

(72) Inventors: Uri TASCH, Baltimore, MD (US); Marcus ZUPAN, Baltimore, MD (US); Ricardo Fernando Rodrigues PINTO, Baltimore, MD (US); Dan TASCH, Baltimore, MD (US)

(21) Appl. No.: 19/136,026

(22) PCT Filed: Dec. 11, 2023
(86) PCT No.: PCT/US2023/083341

§ 371 Date: Jun. 5, 2025

Related U.S. Application Data
(60) Provisional application No. 63/432,109, filed on Dec. 13, 2022.

(51) Int. Cl. A01L 11/00; A01L 15/00

(52) U.S. Cl. CPC A01L 11/00; A01L 15/00

(57) ABSTRACT

An instrumented hoof tester can include a first arm that instrumented (an instrumented arm) and a second arm that does not include instrumentation (e.g, a manual arm. Each of the two arms can include corresponding jaws and handles, and they are hinged together at a pivot point. The pivoting interconnection of the arms aligns the ends of the jaws and provides for movement of the manual jaw and the instrumented jaw along an engagement path.

### CROSS-REFERENCE TO RELATED APPLICATIONS

This application claims priority and benefit under 35 U.S.C. § 119(e) to U.S. Provisional Patent Application No. 63/432,109, entitled “Instrumented Hoof Tester”, filed on Dec. 13, 2022. The content of that application is incorporated herein in its entirety by reference.

### BACKGROUND OF THE INVENTION

A standard hoof tester is a common tool used by animal care experts to evaluate the hoof of an animal for signs of any ailments or diseases such as lameness. Standard hoof testers have been part of this practice for generations and are a vital tool in any health or hoof care expert's toolbox in various industries such as bovine and equine veterinarians, horse trainers and farriers, cow hoof trimmers, etc.

A standard hoof tester looks like an enlarged set of pliers that is being used by hoof care practitioners to assess if an animal suffers from any sensitivity or pain when pressure is applied on their hooves. Current standard hoof testers are the most common tool on the market that enables the users to apply force on selected test points of a hoof and observe whether the animal responds and reacts by retracting his/her limb. Limb retraction is evidence of pain to which the animal is responding, but the applied force is not being measured thus one does not know at what magnitude of applied force the animal was responding. The standard hoof tester is used to squeeze the animal's hoof across various test points while the operator observes whether the animal responds to the applied squeezing force. When the animal is sensitive to the applied squeezing force, the animal will retract his/her limb and, in the absence of a sensitivity or discomfort, the animal will not respond and s/he will not retract their limb.

A standard hoof tester is operated only by feel, meaning the operator determines sensitivity level merely based on when the animal reacts to the intensity of the operator's squeezing forces. In essence, when an operator finds that an animal can withstand a great deal of pressure during operation then it is seen as a healthy test point of the hoof. However, if the animal reacts by jumping or pulling away from the operator in response to simply a small amount of squeezing force during operation then the operator finds that test point of the hoof to be a problem area. While an operator might repeat the operation multiple times in hopes of reducing errors, the error will nevertheless remain inherent because the standard hoof tester's sole basis of results relies on the operator's subjective feel and experience. Moreover, external factors, which include but are not limited to operator fatigue and fitness, climate and local environment will bias the results. The intrinsically biased results of current standard hoof tester results cannot be compared across operators. Accordingly, the current standard hoof testers have a steep learning curve and must only be utilized by practitioners with professional training to not risk the animal's and the operator's health or safety during operation.

The standard hoof tester is used by propping the animal's limb off the ground in order to access the bottom of the hoof. This procedure varies depending on the animal to be tested as well as on the skill, comfort and knowledge of the operator. For example, cows are individually herded into a chute that holds them safely while each limb is carefully lifted and secured into an upright position with a rope and pulley system. In contrast, due to the highly trained nature of horses, the hoof testing procedure simply requires lifting the horse's limb and holding it upright by utilizing one's knees or thighs to squeeze the hoof between the operator's legs, or any similar technique that is safe and comfortable for both the test animal and operator.

A primary problem with the current standard hoof testers even in the hands of skilled practitioners is the fact that one does not measure the applied squeezing force applied on the hoof. By not being able know the applied squeezing force, the operation of currently available standard hoof testers results in inconsistent assessments of hooves' sensitivity within and across expert operators. In addition, use of standard hoof testers results in inconsistent levels of applied squeezing forces, and biased qualitative measures of the animal's pain sensitivity. The standard hoof tester can only provide results in a binary subjective manner (i.e., it is either a sensitive or not sensitive outcome) that merely reveals a broad and basic understanding of the health of the animal.

Only trained and experienced individuals should use standard hoof testers. Before using the standard hoof tester, one should be educated on the correct techniques and procedures for conducting a thorough examination. There are alternative methods that may provide more accurate diagnosis than standard hoof testers to avoid potential problems associated with standard hoof testers, and can be used in conjunction with or in place of the standard hoof testers. Some practitioners may use nerve and joint blocks, which involve injecting a local anesthetic to temporarily numb the problem area in question to help identify the source of lameness. The cost and ease of use of these alternative methods compared to standard hoof testers can be expensive and require specialized equipment and training like the standard hoof testers. While using standard hoof testers by skilled experts may be more accessible, the accuracy and comprehensiveness of the lameness assessment will suffer. Accordingly, the prior art fails to overcome these shortcomings as well as other drawbacks exist.

### SUMMARY OF THE INVENTION

The instrumented hoof testers disclosed herein represent a significant advancement in the field of hoof testing for horses, cows, pigs, goats, sheep, and other hoofed test subjects. The instrumented hoof testers address several of the limitations and challenges associated with currently available tools while introducing a vast range of innovative features and functionalities. The exemplary features and benefits of the instrumented hoof testers mark a significant advancement, offering practitioners and operators a valuable diagnostic tool, for example, to maintain the health and well-being of horses, cows, pigs, goats, sheep, and other hoofed test subjects.

According to various embodiments of the disclosure, the instrumented hoof testers are groundbreaking tools in the field of veterinary care, hoof health management and a vast array of other fields. The instrumented hoof testers may provide an accurate, objective, and safe method and system for assessing the status and sensitivity of different test subjects, ensuring early detection and tailored treatment while maintaining a sterile and controlled testing environment. The instrumented hoof testers may maintain a clean and balanced design with easy handling that ensures a clear and unobstructed view of the test subject during operation.

As depicted by various exemplary embodiments of the invention, the instrumented hoof testers may offer accurate and objective digital quantification, eliminating errors due to, for example, the operator's bias. By displaying generated measurements in real-time, the instrumented hoof testers may allow operators to monitor and adjust applied pressure appropriately, minimizing the risk of causing intense pain or injury to the test subject. This real-time feedback may help operators avoid harming the test subject while obtaining essential data regarding the status of the test subject.

By providing comparisons of measurements to updatable scoring protocols, various embodiments of the disclosure further provide the instrumented hoof testers may reveal unknown problems in their early stages, facilitating prompt action or treatment. Early detection is critical for maintaining the test subject's health and well-being, as well as confirming acceptable conditions for quality assurance of test subjects. Regular use of the instrumented hoof testers may help identify issues in a test subject before they become severe, promoting preventative measures and the overall health and status of the test subject.

By way of example, the instrumented hoof testers may identify subtle pain or discomfort in the test subject at early stages of onset, enabling timely treatment before conditions become severe. The instrumented hoof testers may pinpoint the exact location of problems, for example, on a hoof the instrumented hoof testers may highlight issues such as abscesses, bruises, or fractures, providing practitioners with invaluable assessment specificity to create tailored treatment plans for the individual test subject. By comparing pain levels via digital force quantification before and after treatment, the instrumented hoof tester may enable practitioners to monitor the progress of treatment and assess its effectiveness.

A first exemplary embodiment of the invention may include an engagement trigger, which is configured for quick and easy removal, reattachment and replacement. A measuring module, located on an instrumented jaw, which according to the first exemplary embodiment may feature a strain gauge with a force sensor affixed to the bottom of its base. The elastic member, in this first exemplary embodiment, may be a cantilever beam that protrudes from the top of the strain gauge's base. The detachable engagement trigger may be aligned with the measuring module and the manual jaw along the engagement path. The engagement trigger may play a pivotal role in the measurement process by deforming the elastic member of the measuring module when the instrumented hoof tester is in operation. The engagement trigger may deform the cantilever beam, causing the strain gauge to bend by a deflection component that is measured by the measuring module.

The detachable engagement trigger is an exemplary advantage of the first preferred embodiment of the instrumented hoof testers. The engagement trigger may not only be removable but also easily reattachable, making it a unique and valuable feature of the instrumented hoof testers. The ability to quickly and easily replace the engagement trigger, or simply its gripping head, provides operators with an efficient solution to maintain continuous testing without the need to disassemble or remove any other parts of the instrumented hoof testers. Accordingly, the instrumented hoof testers may not only save time for operators but also may ensure that the instrumented hoof testers remain in operation without extended downtime and avoid disruptions in testing operations or routines to reduce undue anxiety on the test subject and the operator. Particularly for environments like farms or racetracks and circumstances requiring evaluation of multiple test subjects under difficult surroundings, the removable and reattachable engagement trigger and gripping head may help maintain a sterile testing environment by allowing the easy part swapping between test subjects and locations to minimize the risk of disease transmission and maintain a sterile testing environment.

A second exemplary embodiment of the instrumented hoof testers may leverage an innovative homogenous design approach by embedding the measuring module, which may feature one or more force sensors, within the arms and/or integrating the measuring module onto the arms. One or more force sensors may be secured to the arms of the instrumented hoof tester such that the one or more force sensors bend along with the arms, conforming to the inherent deformation of the instrumented hoof tester's structure. The arms may accordingly symmetrically deform together or independently advantageously forming the elastic member in the second exemplary embodiment of the invention.

The embedded and/or integrated force sensors may be strategically placed throughout the instrumented hoof tester, offering precision and flexibility in the design to maximize measurement accuracy and sensitivity. The distributed placement of one or more force sensors ensures that the instrumented hoof tester may be easy to balance and handle, making it user-friendly and comfortable to use. With fragile parts housed within the arms of the instrumented hoof tester, for example by employing hollowing tubing, the instrumented hoof tester may maintain a clean and balanced design to minimize intrusions in along the engagement path and ensure that operators have a clear and unobstructed view of the test subject. The second exemplary embodiment of the instrumented hoof testers may include a calibration process where, for example, a calibration block is utilized to establish a benchmark for the measured and applied forces. The benchmark may then be correlated with the deflection component of each of the embedded and/or integrated force sensors, ensuring accurate and precise measurements.

According to various embodiments of the disclosure, a controller may be a crucial feature for the instrumented hoof testers that processes, analyzes and stores the measured forces along with other pertinent data regarding the operator and/the test subject. The controller may be directly or wirelessly connected to the measuring module or other features of the instrumented hoof testers. Additionally, the controller may be paired with an auxiliary device located remotely or mounted to the instrumented hoof testers in the same fashion as the controller, expanding the functionality and data management capabilities. The controller may create and store log files for individual test subjects, facilitating long-term tracking of changes in sensitivity and treatment effectiveness. Fasteners may secure the controller to the instrumented hoof testers, offering a strong and dependable yet removable attachment mechanism that ensures alignment of the measuring module and the engagement trigger with the manual jaw along the engagement path while also allowing safe cleaning, maintaining and keeping of the instrumented hoof tester with easy removal of the controller.

Various other objects, features, and advantages of the invention will be apparent through the detailed description of the preferred embodiments and the drawings attached hereto. It is also to be understood that both the foregoing general description and the following detailed description are exemplary and not restrictive of the scope of the invention.

### BRIEF OF DESCRIPTION OF THE DRAWINGS

FIG. 1 is an illustration of an example instrumented hoof tester having a sliding engagement trigger mechanism for digital quantifiable analysis, monitoring and evaluation according to one embodiment of the disclosure.

FIG. 2(a) is an assembled isometric view of an example instrumented jaw having an easily removable and reattachable engagement trigger and controller fastened to it according to an embodiment of the disclosure.

FIG. 2(b) is a disassembled isometric view of an example instrumented jaw having an effortlessly removable and reattachable controller and engagement trigger, which is also replaceable with substitute parts according to an embodiment of the disclosure.

FIG. 3(a) is a disassembled isometric view of the example instrumented jaw showing one example of fastening and securing of the detachable controller shown to be transparent revealing its internal features according to an embodiment of the disclosure.

FIG. 3(b) is a transparent back view of an easily reattachable controller fastened and secured to the example instrumented jaw according to an embodiment of the disclosure.

FIG. 4 is a cross-sectional view of an easy to detach, reattach and replace engagement trigger directly aligned and secured with a measuring module that includes a strain gauge held on the example instrumented jaw according to an embodiment of the disclosure.

FIG. 5(a) is an assembled isometric view of another exemplary instrumented jaw having a protective canister design showing another example of simple fastening and securing a reattachable controller according to an embodiment of the disclosure.

FIG. 5(b) is a dissembled isometric view of the exemplary canister design of an example instrumented jaw showing another example of fastening and securing of the detachable controller according to an embodiment of the disclosure.

FIG. 5(c) is a detailed view of a preferred snap fit mechanism of an exemplary canister design for fastening and securing of the removable controller according to an embodiment of the disclosure.

FIG. 6 is an illustration of another example instrumented hoof tester having embedded and integrated measuring module design for digital quantifiable analysis, monitoring and evaluation according to a second embodiment of the disclosure.

FIG. 7 is an isometric view of an exemplary jaw shown to be transparent to reveal an example cavity to embed one or more force sensors into the shape and the geometry of the exemplary embodiment of the instrumented hoof tester.

FIG. 8 is an isometric view of an exemplary jaw shown to be transparent to reveal implementation of multiple force sensors embedded in the arms conforming to the inherent deformation of the exemplary embodiment's structure according to an embodiment of the disclosure.

FIG. 9 is an isometric view of an exemplary jaw shown to be transparent to reveal an example wedge to embed one or more force sensors onto the shape and the geometry of the exemplary embodiment of the instrumented hoof tester.

FIG. 10(a) is an isometric view of an exemplary jaw configured to allow quick securing and detaching of the controller from various locations and orientations along the exemplary embodiment of the instrumented hoof tester.

FIG. 10(b) is a detailed view of a preferred snap fit mechanism for easy fastening and securing of the removable controller to the arms of an instrumented hoof tester according to an embodiment of the disclosure.

FIG. 11 is an isometric view of an exemplary jaw shown to be transparent to reveal the hollow tubing housing and sealing various components of an instrumented hoof tester according to an embodiment of the disclosure.

FIG. 12 is a block diagram of an exemplary controller and its associated example modules to perform numerous functionalities for an instrumented hoof tester according to an embodiment of the disclosed invention.

FIG. 13 shows one example of methodologies for general operation of and best practices for an example instrumented hoof tester according to an embodiment of the disclosure.

### DETAILED DESCRIPTION OF THE DISCLOSURE

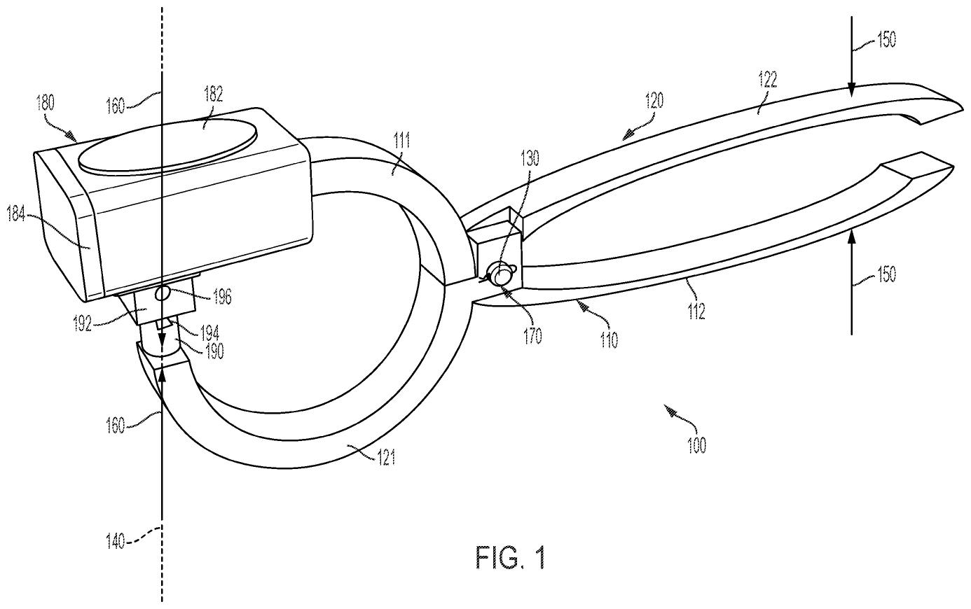

FIG. 1 depicts one exemplary embodiment of the instrumented hoof tester 100. The instrumented hoof tester 100 may consist of an instrumented arm 110 and a manual arm 120, where each arm 110, 120 includes corresponding jaws 111, 121 and handles 112, 122. The instrumented arm 110 and the manual arm 120 may be hinged together at a pivot point. For example, this interconnection between the arms is established using an interlocking pin 130. The pivoting interconnection of the arms 110, 120 aligns the ends of the jaws 111, 121 and provides for movement of the manual jaw 120 and the instrumented jaw 110 along an engagement path 140.

When pressure via the user force component 150 is applied to each of the handles 112, 122 by squeezing the first handle 112 and second handle 122 together, the jaws 111, 121 of the instrumented hoof tester 100 move towards each other along the engagement path 140 in order to engage and hold a test subject between the jaws 111, 121 of the instrumented hoof tester 100. Such that during operation of the instrumented hoof tester 100, the user force component 150 applied to the handles 112, 122 generates a translated force component 160 at the ends of the jaws 111, 121. In contrast, when pressure via the user force component 150 is released from the handles 112, 122 by moving the first handle 112 and the second handle 122 away from each other, the jaws 111, 121 of the instrumented hoof tester 100 move away from each other in order to disengage and release the test subject from the jaws 111, 121 of the instrumented hoof tester 100.

The instrumented hoof tester may incorporate a pivot point 170 medially positioned along the arms 110, 120 in a plier-style configuration. By providing a lever design, the instrumented hoof tester 100 may mechanically amplify the user force component 150 applied by the operator to the handles 112, 122. For any given overall length of the instrumented hoof tester 100, longer handle 112, 122 lengths increase the applied force gain for the operator. For example, given 12-inch-long handles 112, 122 and an overall length of 16 to 17 inches for the instrumented hoof tester 100, the user force component 150 is approximately amplified by 2.5. The ideal handle 112, 122 dimensions may be balanced between ergonomics for the operator and force application range required for the test subject as well as the field of use. For example, testing of equine and bovine hooves, a preferred length for the handles 112, 122 may range from 10-19 inches, enabling effective one- or two-handed use of the instrumented hoof tester 100 and achieving a suitable force application range (e.g., 0-150 pounds) while maintaining proper clearance between the instrumented jaw 111 and the manual jaw 121 to accommodate various hoof sizes (e.g., 4-8 inches). Accordingly, the exemplary plier-style configuration of the instrumented hoof tester 100 may amplify the squeezing force providing for sensitive hoof testing, with a user force component 150 gain tailored via pivotal leverage and handle 112, 122 length. The positioning of the pivotal connection at the pivot point 170 and the handles' 112, 122 lengths may be optimized for the force range requirements and the shape, dimension and size of the test subject in any application.

While the exemplary embodiment focuses on hoof testing for bovine and equine test subjects, the instrumented hoof tester 100 and its advantageous measurement principles apply across many industries. Beyond hoof and limb analysis, potential applications and test subjects include, but not limited to, medical diagnostics to provide palpation and tactile examination of human anatomy (e.g., musculoskeletal, dermatological, etc.); food science to enable precise mapping of tactile properties such as softness, ripeness, and crispiness; manufacturing to test hardness and tactile qualities for materials, textiles, and/or consumer products; other animal fields such as ovine, caprine and swine to standardize behavioral assays of touch sensitivity in animal models; metallurgy and mining to assess ore density and karat of precious metals; and archeology and paleontology to determine fossil brittleness and tool preservation. The instrumented hoof tester 100 advantageously enables digital quantitative mapping of tactile variables in any field requiring sensitive grasping and material manipulation. The instrumented hoof tester 100 exemplifies a universal platform to objectively measure gripped force across industries and use cases requiring precise haptic feedback and control. For example, the force-quantifying functionality of the instrumented hoof tester 100 provides objective tactile feedback for delicate gripping tasks. Further, the pivot point 170 may be positioned at the end of the arms to form a forceps-shaped design, which might be beneficial for applications that require reduced force application and/or a few fingers to operate such that two-handed gripping might interfere with operation.

The instrumented arm 110 may be configured to secure and hold a controller 180. The instrumented jaw 111 of the instrumented arm 110 may be modified to fit a measuring module housed in the controller 180 on the instrumented jaw 111. However, the controller 180 may also be fastened to and/or on any portion of the instrumented hoof tester 100 and/or positioned separately from the instrumented hoof tester 100 at a remote location as long as the measuring module is properly aligned on the engagement path 140 to measure the translated force component 160. The controller 180 contains, among other elements, a user module 182 to display measurements, a measuring module (inside the controller 180) for force sensing, and a protective case 184 housing these components and all the various modules and/or elements of the controller 180. The protective case 184 beneficially shields the controller's 180 internal elements from environmental hazards and potential mishaps (e.g., dropping), and positions the user module 182 for the operator's viewing. The protective case 184 may be made of materials that ease securement of the controller 180 to the instrumented arm 110 of the instrumented hoof tester 100. For example, a protective case 184 formed of metal material may be welded to arms 110, 120 also made of metal material. The controller 180 may also be fastened to the instrumented hoof tester 100 by various other means or located remotely as detailed herein. The instrumented jaw 111 of the instrumented arm 110 holds the controller 180 to process and display the measurements generated by the measuring module, among other functionalities. Thus, the controller's 180 placement and location may be advantageously modular, and the protective case 184 protects the internal elements and/or modules of the controller 180 while positioning the user module 182 for optimal display.

An engagement trigger 190 may be configured on the instrumented jaw 111 to align with the measuring module of the controller 180 secured to the instrumented jaw 111 of the instrumented arm 110 and with the end of the manual jaw 121 of the manual arm 120 along the engagement path 140. One end of the engagement trigger 190 faces the manual jaw 121, and the other end faces the measuring module housed in the controller 180. The engagement trigger 190 may align with and be directly fastened to the measuring module of the controller 180 as described in greater detail herein. Alternatively, the engagement trigger 190 may be held in alignment via a slide mechanism 192 that allows limited movement (e.g., ranging from 0.1 to 3 inches) of the engagement trigger 190 along the engagement path 140. As the instrumented jaw 111 and the manual jaw 121 are squeezed together via application of the user force component 150 to the handles 112, 122, the engagement trigger 190 may press against the measuring module to beneficially allow precise measurement of the translated force component 160. Therefore, the movable engagement trigger 190 slides and interfaces between the manual arm 121 and the controller 180 to enable accurate force measurement during the operation of the instrumented hoof tester 100. A slot 194 may run through the engagement trigger 190 to fit a slide pin 196. The slide pin 196 sits on the slide mechanism 192 and through the slot 194 of the engagement trigger 190 to hold the engagement trigger 190 in proper alignment with the manual jaw 121 of the manual arm 120, allowing and limiting movement of the engagement trigger 190 along the engagement path 140. While in operation movement of the engagement trigger 190 presses against the measuring module of the controller 180 to accurately measure the generated force components 150, 160.

When in operation and squeezing the handles 112, 122 together, the controller 180 may be equipped to measure the translated force components 160 generated by the user force components 150 applied on the handles 112, 122. In practice with the instrumented hoof tester 100, the operator may apply quantized squeezing forces to several various regions of interest on the same test subject. By way of example for hoofed test subjects, controlled increments of pressure may be applied to localized areas of the same hoof while monitoring the withdrawal response of the test subject. Accordingly, the instrumented hoof tester 100 beneficially enables construction of mapped hoof sensitivity digital profiles, with objective force measurements that correlate to visible pain reactions. The instrumented hoof tester 100 advantageously eliminates subjective tactile cues, providing reproducible mechanical pressure escalation. Limb retraction response observed by an operator may indicate the precise tissue-buckle force threshold causing discomfort to facilitate establishment of scoring protocols as detailed herein. Accordingly, the instrumented hoof tester 100 beneficially permits, for example, scientifically nudging this pain boundary with high specificity to pinpoint underlying pathologies. The instrumented hoof tester 100 may offer standardization of manual palpation via methodical user force application 150 and digital feedback, allowing an operator to objectively probe tissue mechanosensitivity by mapping anatomical force response topographies and sensitivities. The controller 180 may display the measured translated force components 160 to the operator via the user module 182. Accordingly, the instrumented hoof tester 100 may advantageously provide the operator with a specific numerical value in known and understandable quantifiable units, such as pound, kilogram, Newton or another dimension.

Quantitative force measurement by the instrumented hoof tester 100 enables data-driven modeling of tactile examination, among other benefits. By applying controlled user force components 150 and recording user scores and observations, the instrumented hoof tester 100 may provide an objective sensitivity profile as well as alerts to the status of the test subject considering established scoring protocols as discussed herein. For example, areas of decreased sensation may indicate underlying pathology like lesions or defects in evaluation of hoofed test subjects. By mapping force response across many anatomical regions (e.g., sole, interdigital zone, wall of a hoof), the instrumented hoof tester 100 may allow precise localization of problems. The instrumented hoof tester 100 may measure and display the generated squeezing force components 150, 160 for each use, assisting the operator to pinpoint various spots of concern on the test subject. Decreased limb withdrawal force may correlate to heightened pain, tissue damage and/or cause of discomfort in each tested area of the test subject. Collectively, quantitative digital sensing by the instrumented hoof tester 100 beneficially adds analytical rigor and localizing precision to qualitative assessment such as hoof testing. By systematizing examination and providing numerical outputs, the instrumented hoof tester 100 may furnish objective, anatomically mapped sensitivity profiles to diagnose and monitor the status of a test subject.

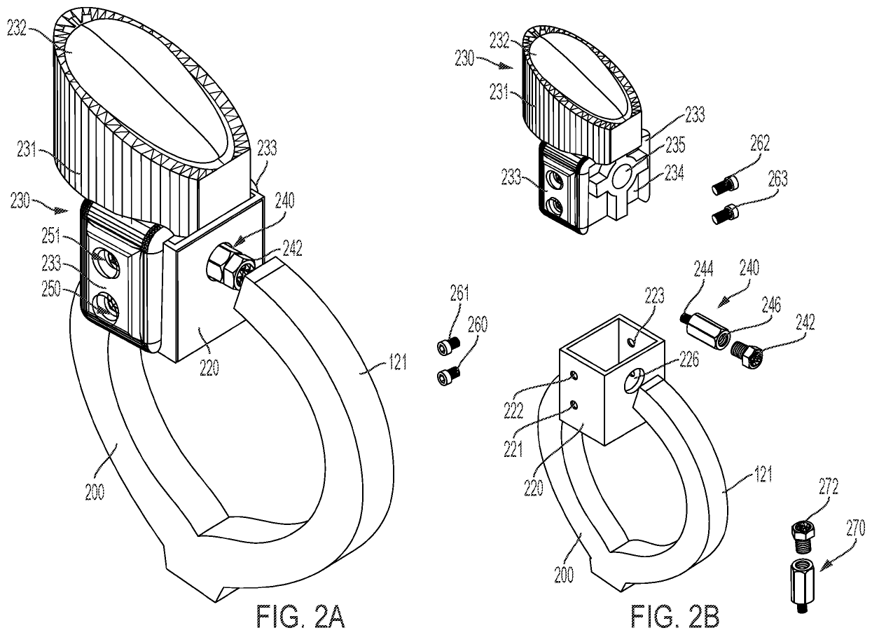

FIGS. 2 (a) and (b) illustrate the jaws 200, 121 of another exemplary embodiment of the instrumented hoof tester 100 having easily detachable and attachable elements. FIG. 2 (a) shows the components of the instrumented hoof tester 100 attached and ready for operation. FIG. 2 (b) shows examples of the components detached from each other.

The instrumented jaw 200, which corresponds with an instrumented arm 110, includes a sleeve 220 to hold the controller 230 and position the engagement trigger 240 in proper alignment with the manual jaw 121, which corresponds with a manual arm 120. The sleeve 220 may include fastener holes 221, 222, 223 for fasteners to fit through and attach the controller 230 to the instrumented jaw 200 into proper orientation. An engagement hole 226 may also be provided on the side of the sleeve 220 facing towards the manual jaw 121 of the manual arm 120 along the engagement path 140, allowing for the simple alignment of the engagement trigger 240 to the controller 230 when attached to the instrumented jaw 200. The sleeve 220 may be made of a material compatible with the material of the jaws 200, 121 and/or their corresponding arms 110, 120 of the instrumented hoof tester 100 to enable integrated fabrication. For example, a sleeve 220 made of aluminum may be welded to an instrumented jaw 200 also made of aluminum for a lightweight and strong instrumented hoof tester 100. Other technical materials like composites or alloys could also be utilized for construction of the sleeve 220 and/or jaws 200, 121. Precise positioning and integrated materials selection may beneficially optimize ergonomics and durability of the instrumented hoof tester 100. The sleeve 220 also advantageously streamlines assembly, disassembly, and field maintenance of the instrumented hoof tester 100. By utilizing materials science and ergonomic engineering to inform the physical design of the instrumented hoof tester 100, the integrated sleeve 220 strengthens the instrumented jaw 200, facilitates controller 230 mounting, and ensures alignment of the engagement trigger 240 for reliable force measurement.

The controller 230 includes a protective case 231 to house the user module 232, among other modules and elements contained in the controller 230. The controller 230 may also include side guards 233 that surround the ends of the fasteners 250, 251 when attached to the sleeve 220, shielding the exposed ends of the fasteners 250, 251 from the operator and test subject and providing a safe covering to eliminate possible sharp edges. The controller 230 may also include a strain gauge holder 234, which houses a measuring module of the controller 230 as further described herein. An access hole 235 may be provided in the strain gauge holder 234 to permit the engagement trigger 240 to align with the measuring module of the controller 230 for precision force measuring functionality when assembled for operation.

Fasteners 250, 251 in addition to corresponding fasteners on the opposing side of the sleeve 220 may be provided to attach the controller 230 to the sleeve 220 of the instrumented jaw 200. The fasteners 250, 251 may be any simple and repeatable means for attachment and detachment of the controller 230 to the instrumented hoof tester 100, including but not limited to, pins screws, bolts, clips, hook and loop, and snaps. The fasteners 250, 251 may include, for example, the threaded bolts 260, 261, 262, 263 configured to run through the side guards 233 of the controller 230 resting against the sleeve 200 to hold the controller 230 by the strain gauge holder 234. With simple removal and attachment of the controller 230 and its fragile modules and/or elements, such as the electronic components, the operator may clean the jaws 200, 121 of the instrumented hoof tester 100 while protecting all the fragile parts of the instrumented hoof tester 100. Further, the detachable controller 230 may be stored separately, preferably in a storage case, during travel with the instrumented hoof tester 100. For example, in the equine and bovine fields, the instrumented hoof tester 100 may be employed in harsh environments such as a dairy farm, horse barn or racetrack. Exposure to such harsh environments requires consistent cleaning for proper maintenance and durability. Thus, by allowing the operator to assemble and disassemble the instrumented hoof tester 100 with ease, the operator will be able to maintain a clean and reliable tool for regular use in the field. The engagement trigger 240 independently may also serve as the means for fastening the controller 230 to the instrumented jaw 200. These various means for fastening and securement of the controller 230 strengthen the attachability, detachability and reattachability of the controller 230 to and from the instrumented jaw 200 and bolster the overall durability of the instrumented hoof tester 100.

The engagement trigger 240 includes a gripping head 242 that is also easily removable and replaceable like the engagement trigger 240. The engagement trigger 240 may have a threaded male end such as a threaded peg 244 detailed herein that engages with the measuring module housed in the controller 230. The engagement trigger 240 may also have a female threaded hole 246 to fit a gripping head 242 that engages with the test subject. The gripping head 242 may have a textured top surface that allows the instrumented jaw 200 to strongly clasp onto the test subject and avoid slipping during operation. Both the engagement trigger 240 and the gripping head 242 may be removed and replaced with substitute parts. For example, a substitute engagement trigger 270 may be used to replace the engagement trigger 240, and independently a substitute gripping head 272 may be used to replace the gripping head 242. By way of example, in testing of humans and animals, the operator must ensure disease prevention between both facilities and test subjects. Accordingly, between testing of different test subjects, the instrumented hoof tester 100 offers the benefit of effortlessly replacing the gripping head 242 with the substitute gripping head 272 that is clean and sanitary for the next test subject. In addition, the modular and interchangeable engagement trigger design enables hygienic swapping and maintenance. Using sterile interchangeable engagement triggers 240, 270 and/or gripping heads 242, 272 prevents cross-contamination between testing sites such as barns, farms, racetracks, and veterinary facilities.

By supplying the substitute engagement trigger 270 and/or the substitute gripping head 272 for simple replacement, the instrumented hoof tester 100 provides maximum infection control compared to cleaning the engagement trigger 240 and/or the gripping head alone 242. The engagement trigger's 240 quick-release design also beneficially allows maintenance access without disturbing fragile internal electronics housed in the controller 230. For example, a threaded attachment between the removable engagement trigger 240 and measuring module of the controller 230 as described herein facilitates rapid in-field sanitation and replacement. By optimizing modularity of its components, the instrumented hoof tester 100 balances measurement precision with biosafety priorities expected in numerous testing environments. The instrumented hoof tester's 100 swappable engagement trigger design advantageously integrates mechanical robustness and hygienic best practices for safe test subject handling and diagnostics.

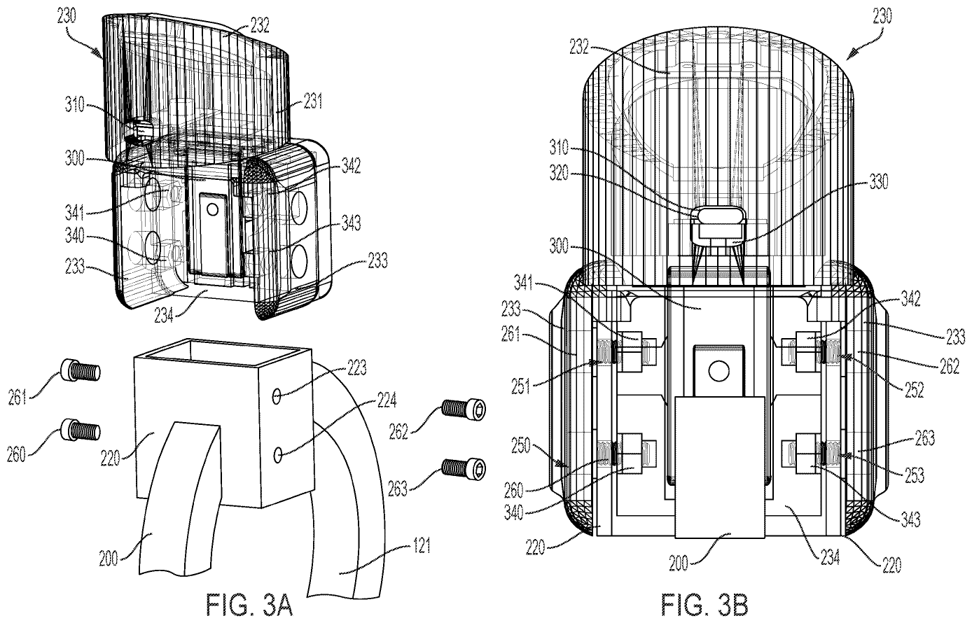

FIG. 3 (a) shows a back view of the instrumented jaw 200 having the controller 230 secured to the sleeve 220. Similarly, FIG. 3 (b) depicts the back view of the controller 230 detached from the instrumented jaw 200.

The controller 230 may house the measuring module, which is illustrated to include a strain gauge 300 in FIGS. 3 (a) and (b). A strain gauge 300 is a well-known device for force measuring by measuring displacement that is converted into units of force, which is utilized in a variety of industries for a wide array of applications. The controller 230 may also include a processing module 310 for computing and processing of the measured translated force components 160 received from the measuring module, in addition to other functionalities detailed herein. The processing module 310 may be electronically connected to the user module 232 for displaying the measured force components 150, 160, among other features described herein. A charging port 320 may be provided as part of the processing module 310 that connects to a power module (not illustrated) in order to recharge the power module and/or power the controller 230. The charging port 320 on the processing module 310 is accessed through a charging port hole 330 formed into the protective case 231 of the controller 230.

All the internal elements and/or modules housed in the protective case 231 of the controller 230 may be connected electronically to each other, for example, via the processing module 310. The protective case 231 may be constructed of lightweight, durable materials, including, for example, injection molded polycarbonates, ABS plastics and/or any other polymer or polymer-based composites to resist impact concerns. In addition, the protective case 231 may be constructed of a high strength material such as stainless steel, aluminum alloys and/or other metal-based materials or composites.

Additive manufacturing via 3D printing, or other similar means of construction enables providing a customized protective case 231 that conforms and fits precisely to the internal elements and/or modules of the controller 230, optimizing form factor while maintaining ruggedness. Alternatively, subtractive manufacturing methods for the controller's 230 protective case 231 such as CNC milling from thermoplastic blocks enable high throughput after initial setup. For example, a multi-piece clamshell design for the protective case 231 allows for easy access to the inside of the controller 230 for maintenance and upgrades to the instrumented hoof tester 100. Weatherproofing components like silicone gaskets and O-ring seals may be utilized in the construction of the protective case 231 to prevent external contamination during use in harsh operating environments. The protective case 231 leverages modern manufacturing techniques and engineered materials to balance durability, electronics access, environmental resistance, and ergonomics, such that the tailored controller 230 ensures reliability in rugged field use.

By way of example, fasteners 250, 251, 252, 253 may include the distal end of each of the threaded bolts 260, 261, 262, 263 configured to lock into the strain gauge holder 234 via a corresponding caddie 340, 341, 342, 343 that is affixed inside the protective case 231 of the controller 230 to fasten and secure the controller 230 to the sleeve 220. The caddies 340, 341, 342, 343 may be affixed directly into recess locations in the strain gauge holder 234 of the controller 230. The caddies 340, 341, 342, 343 provide indexed attachment points to secure the threaded bolts 260, 261, 262, 263 to the controller 230 and to reinforce controller 230 alignment with the manual jaw 121. For example, the caddies 340, 341, 342, 343 may be resistance welded and/or brazed for high-strength attachment to a protective case 231 made of metal material. Moreover, adhesives such as structural acrylics and/or epoxy may provide versatile chemical bonding for affixing the caddies 340, 341, 342, 343 to the protective case 231. By maintaining positive fastener alignment such as accomplished with the caddies 340, 341, 342, 343 and the threaded bolts 260, 261, 262, 263, the controller 230 and the measuring module are fixed in the proper position with respect to the manual jaw 121 along the engagement path 140 to advantageously bolster force measurement accuracy. Proper orientation of the user module 232 of the controller 230 may also be achieved with the precise and secure placement by the fasteners 250, 251, 252, 253 to optimize display to the operator.

For example, each of the caddies 340, 341, 342, 343 may consist of a nut that in combination with a threaded bolt 260, 261, 262, 263 having a threaded male end to fit into each of the caddies 340, 341, 342, 343 in order to form a fastener 250, 251, 252, 253 that beneficially permits repeated attachment and detachment of the controller 230 without causing damage to the components of the instrumented hoof tester 100. Threaded and/or press-fit fasteners 250, 251, 252, 253 aligned to the fastener holes 223, 224 (including fastener holes 220, 221 shown in FIG. 2(b) above) may advantageously allow for reliable insertion and removal of the controller 230 from the sleeve 220 without compromising alignment integrity. The head end of each of the threaded bolts 260, 261, 262, 263 presses against the outside surface of the sleeve 220 to hold the controller 230 in place when secured to the instrumented jaw 200. The side guards 233 on the controller 230 cover the head ends of the threaded bolts 260, 261, 262, 263, protecting operators and test subjects from potential injury by the exposed ends of the fasteners 250, 251, 252, 253.

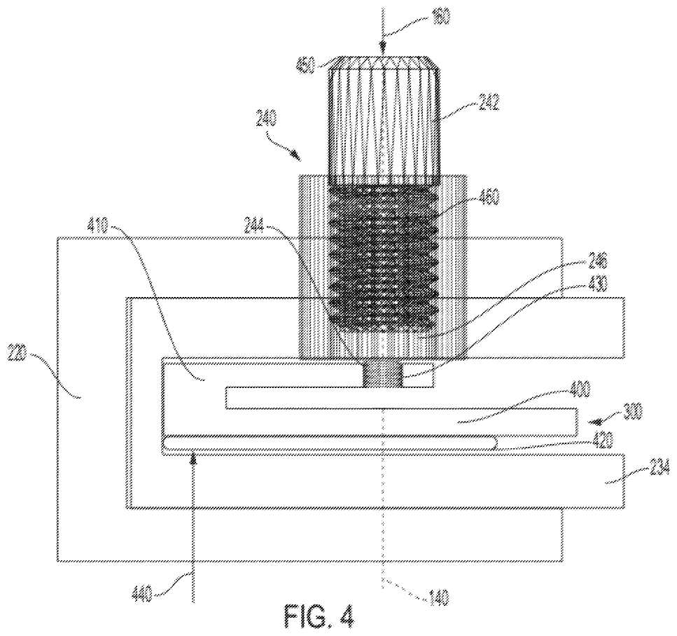

FIG. 4 illustrates an example of the fastening between an engagement trigger 240 to a strain gauge 300 that is simple to attach and detach by an operator and supports meticulous measuring functionalities. The strain gauge 300 is positioned inside the strain gauge holder 234 which sits in the sleeve 220. Both the sleeve 220 and the strain gauge holder 234 have voids to allow the engagement trigger 240 to fit through each of them and align the engagement trigger 240 with the strain gauge 300 along the engagement path 140. A measuring module which is shown as a strain gauge 300 may consist of a base 400 and a cantilever beam 410 extruding from the top of the base 400. A force sensor 420 is adhered to the bottom of the base 400 in a parallel direction to the cantilever beam 410. The cantilever beam 410 includes a threaded hole 430 to permit direct attachment of the engagement trigger 240 to the strain gauge 300. The applied user force components 150 (not shown) coupled with the translated force components 160 generated along the engagement path 140 will cause a shear force in the form of a deflection component 440 in the opposite direction of the translated force component 160, deforming the cantilever beam 410 that serves as the elastic member and causing the force sensor 420 to bend by the deflection component 440 in order to measure generated translated force components 160 accurately. When the applied user force components 150 are released by the operator, the engagement trigger 240 may return the cantilever beam 410 of the strain gauge 300 back to its original shape and the force sensor 420 may also return to its original shape, such that the force sensor 420 conforms to the deformation of the cantilever beam. Accordingly, the release of the applied user force components 150 from the handles 112, 122 may advantageously tare (i.e., zero) the measuring module.

As detailed above, the engagement trigger 240 includes a gripping head 242 that may be easily replaceable and interchanged with substitute parts. One end of the gripping head 242 may have a textured top surface 450 to assist grasping of the test subject. Another end of the gripping head 242 may be a male threaded end 460 that secures into a female threaded hole 246 of the engagement trigger 240. The engagement trigger 240 may also have a threaded peg 244 on the opposite side to the female threaded hole 246. The threaded peg 244 of the engagement trigger 240 is configured to fit into the threaded hole 430 formed in the cantilever beam 410 of the strain gauge 300. Accordingly, the engagement trigger 240 and the strain gauge 300 are directly attached to each other in a manner that makes it easy to disconnect and ensures proper movement along the engagement path 140. The direct connection between the engagement trigger 240 and measuring module may also advantageously serve as a fastener to secure the controller 230 to the instrumented hoof tester 100.

In addition, the threaded direct fastening between the strain gauge 300 and the engagement trigger 240 beneficially removes any unwanted stress on the strain gauge 300 during operation, reducing the likelihood of physical damage to the strain gauge 300 or other components of the instrumented hoof tester 100 caused by overloading such as when the operator applies forces greater than a predetermined threshold (e.g., 250 pounds). This predetermined threshold will vary depending on the design and purpose of the instrumented hoof tester 100. Similar protections may be accomplished electronically by automatically stopping the strain gauge 300 from measuring once a predetermined maximum threshold (e.g., 250 pounds) is reached, and displaying an error message via a user module 232 to the operator to stop further overload application.

During operation, the cantilever beam 410 of the strain gauge 300 may undergo elastic deflection upon engagement trigger 240 loading and thus functions as a mechanical amplifier. The shape and the geometry of the cantilever beam 410 concentrates stresses at the base 400 to locally enhance the strain bending the force sensor 420 affixed to the base 400. The flexure of the force sensor 420 induces piezoresistive variations in a Wheatstone bridge as described below such that the piezoresistive variations are proportional to the applied shear force. By employing solid mechanics principles, the shape and the geometry of the cantilever beam 410 may provide mechanical advantages and improve the force sensor's 420 sensitivity. For example, finite element analysis (FEA) may be utilized to optimize the cantilever beam's 410 thickness and length to target various force ranges to be measured. The cantilever beam 410 may beneficially concentrate force sensing strains for sensitive engagement triggering translation that leverages mechanical amplification principles to boost measurement resolution, widen dynamic range, and ensure overload protection.

A strain gauge 300 is commonly used instrumentation in a wide range of commercial applications such as geotechnical structural monitoring as well as scales and weighing systems. Accordingly, a strain gauge 300 is available in various shapes and sizes depending on the purpose and operating range of the application. For example, for an instrumented hoof tester 100 designed specifically for testing bovine and equine hoofs, a strain gauge 300 having overall dimensions of approximately 0.75-inch width, 2-inch length, and 0.5-inch thickness and a weight of about half an ounce may be utilized. The strain gauge 300 may be either E-shaped, L-shaped or other common shapes available on the market. One exemplary advantage of using such a well-known strain gauge 300 is that the base 400 is substantially flat providing a default zero baseline for the affixed force sensor 420 without requiring further calibration.

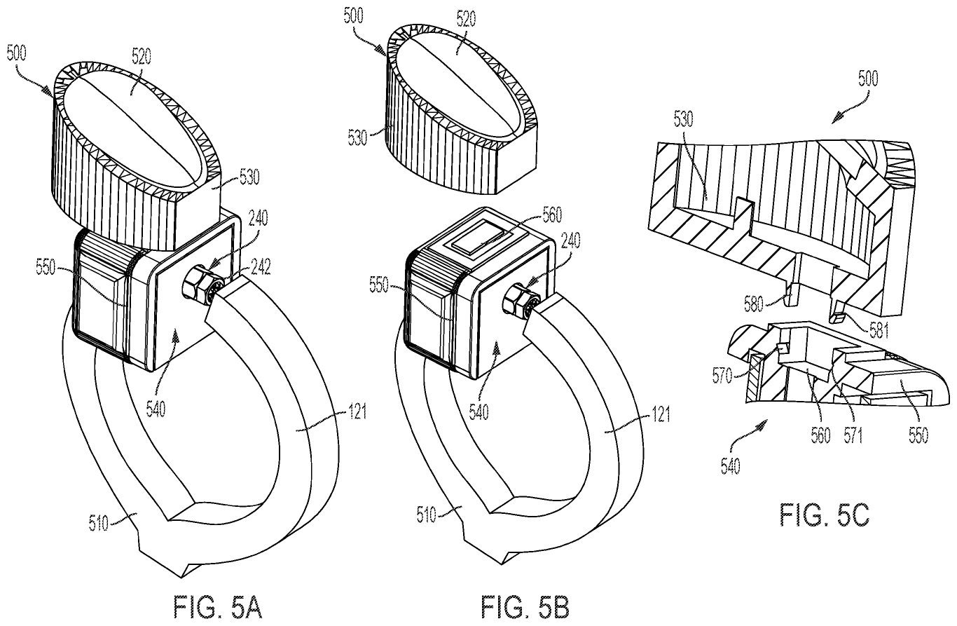

FIGS. 5 (a), (b) and (c) illustrate another exemplary embodiment of the instrumented hoof tester 100 having a controller 500 that is easily attachable, detachable and reattachable. FIG. 5 (a) shows the controller 500 attached to the instrumented jaw 510. FIG. 5 (b) shows the controller 500 detached from the instrumented jaw 510. FIG. 5 (c) depicts a detailed view of the effortless means for attachment, detachment and reattachment of the controller 500.

The controller 500 may have a user module 520 and a protective case 530 as detailed above. The protective case 530 houses the user module 520 and other modules (not illustrated) of the controller 500. The protective case 530 of the controller 500 is configured to encase the internal electronics, including, for example, accommodation of the user module 520 in a viewable and functional area during operation. In this exemplary design, the fragile elements such as the user module 520 and other internal electronic components housed in the protective case 530 of the controller 500 may not only be easily removed for safe storage and cleaning but also are quickly resecured to the instrumented jaw 510 for simple continuous operation.

A canister 540 affixed to the distal end of the instrumented jaw 510 of the instrumented hoof tester 100, which is part of a corresponding instrumented arm 110 (not completely illustrated) of the instrumented hoof tester 100. The canister 540 holds the measuring module in a weatherproof container to protect the measuring module when, for example, the instrumented hoof tester 100 is cleaned by the operator and/or during travel or storage of the instrumented hoof tester 100. A protective wrap 550 surrounds the canister 540 to provide additional weatherproofing and shielding of the internal measuring module from the outside environment. Moreover, the protective wrap 550 may provide a smooth and soft exterior surface on the canister 540 for the safety of the test subject and the operator. Weatherproofing components like silicone gaskets and O-ring seals may be utilized in the construction of the canister 540 and the controller 500 to prevent external contamination during use in severe operating environments.

A connection platform 560 may be provided on the top of the canister 540 that covers and protects the measuring module housed in the canister 540. The connection platform 560 may have snap female ends 570, 571 to fit with snap male ends 580, 581 on the controller 500 in order to fasten the controller 500 to the canister 540. The connection platform 560 ensures the measuring module is protected when the controller 500 is removed from the canister 540. Snap female ends 570, 571 may be arranged on both sides of the connection platform 560 to allow simple attachment and detachment of the controller 500 via snap male ends 580, 581 arranged on the bottom of the controller 500. The snap female ends 570, 571 may be designed into the canister 540 at the connection platform 560, which may be aligned with the corresponding snap male ends 580, 581 formed on the bottom of the controller 500. The snap fit design is one exemplary means for securing and detaching the controller 500 to the canister 540; other means include, but are not limited to, pins, screws, bolts, hook and loop, clasps, clamps and clips or other similar means for repeatable securing and detaching of the controller 500 to the canister 540. Accordingly, the controller 500 may have a one-step simple removal and attachment procedure that maintains strong safeguarding of the internal electronics housed inside the protective case 530.

The engagement trigger 240 may include a gripping head 242, which interacts with the measuring module and aligns with the manual jaw 121 that corresponds to a manual arm 120 (not fully shown) of the instrumented hoof tester 100 as detailed herein. All the benefits and features described herein with respect to the engagement trigger 240 and generation of the force measurements apply to this exemplary embodiment of the instrumented hoof tester 100. In this exemplary instrumented hoof tester 100, removing the engagement trigger 240 and/or additional fasteners is not required to disassemble the instrumented hoof tester 100, thus the implementation of the exemplary snap fit connection means via the snap female ends 570, 571 and snap male ends 580, 581 allows one-step, quick and easy attachment and detachment of the controller 500 by the operator. Thus, the snap fit design may ultimately reduce the likelihood of malfunction or breakage with long-term use of the instrumented hoof tester 100.

Assembly of the instrumented hoof tester 100 by securing the controller 500 to the canister 540 may enable sound mechanical and structural attachment of the instrumented hoof tester 100 as well as establish electronic connection of the measuring module held in the canister 540 to the various modules housed in the controller 500. Additional modules and/or elements such as a communications module may be housed in the canister 540 with the measuring module to provide remote connection capabilities between the measuring module and the controller 500. An insulation seal may be provided along the bottom of the protective case 530 of the controller 500 surrounding the snap male ends 580, 581 and bolstering protection of the internal components from any potential outside hazards.

The canister 540 may be permanently affixed and positioned on the instrumented jaw 510, which provides for the measuring module to remain in consistent alignment with the engagement trigger 240 ensuring refined digital measurement readings. The advantage of safeguarding the alignment of the measuring module and the engagement trigger 240 with quick and straightforward attachment and detachment of the controller 500 may make assembly and disassembly more accessible for operators of any level of experience.

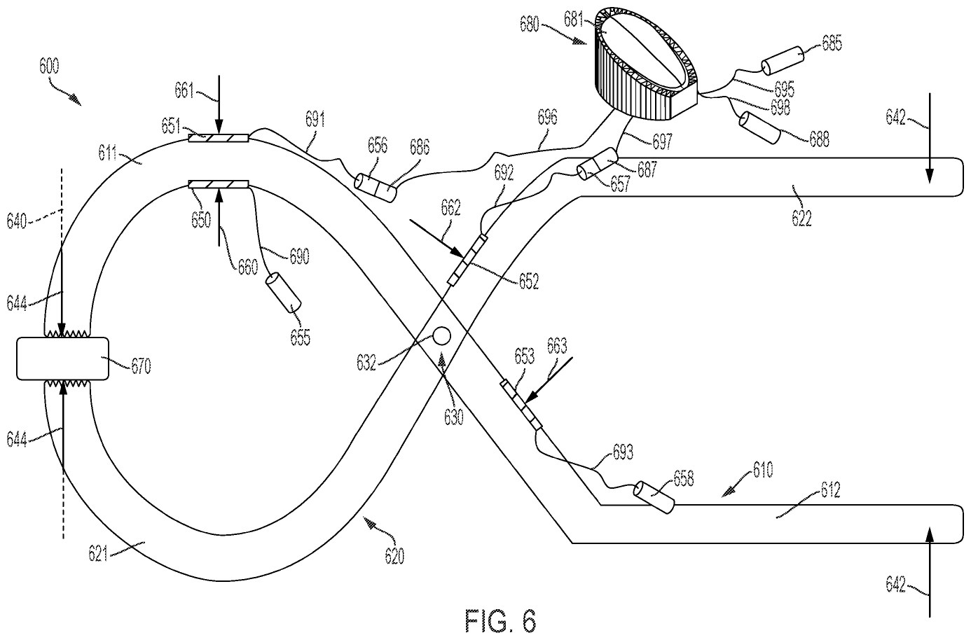

FIG. 6 depicts another exemplary embodiment of the invention that embeds and integrates the measuring module as part of the arms 610, 620 of the instrumented hoof tester 600. The instrumented hoof tester 600 may consist of a first arm 610 and a second arm 620, where each arm 610, 620 includes corresponding jaws 611, 621 and handles 612, 622. The first arm 610 and the second arm 620 may be hinged together at a pivot point 630. This interconnection between the first arm 610 and the second arm 620 may be established using an interlocking pin 632. The pivoting interconnection of the first arm 610 and the second arm 620 aligns the ends of the jaws 611, 621 and provides for movement of the jaws 611, 621 along the engagement path 640.

When pressure via the user force component 642 is applied to each of the handles 612, 622 by squeezing the first handle 612 and the second handle 622 together, the jaws 611, 621 of the instrumented hoof tester 600 move towards each other along the engagement path 640 in order to engage and hold a test subject between the jaws 611, 621 of the instrumented hoof tester 600. Such that during operation of the instrumented hoof tester 600, the user force component 642 applied to the handles 612, 622 generates a translated force component 644 at the ends of the jaws 611, 621. In contrast, when pressure via the user force component 642 is released from the handles 612, 622 by moving the first handle 612 and the second handle 622 away from each other, the jaws 611, 621 of the instrumented hoof tester 600 move away from each other in order to disengage and release the test subject from the jaws 611, 621 of the instrumented hoof tester 600. The release of pressure from the first handle 612 and the second handle 622 may also advantageously tare (i.e., zero) the embedded and/or integrated measuring module (illustrated here as one or more force sensors 650, 651, 652, 653) by allowing the measuring module to return to its original shape and geometry, following and conforming to the natural deformation of the arms 610, 620 that form the elastic member for triggering measurement by the measuring module. There are various means and configurations to secure the force sensors 650, 651, 652, 653 as well as other components onto or into the instrumented hoof tester 600 in order to capture the advantage of the characteristic deformation of the arms 610, 620 that inherently materializes during application of the user force components 642 to the handles 612, 622 of the instrumented hoof tester 600 and corresponding generation of the translated force components 644 to the jaws 611, 621 of the instrumented hoof tester 600.

The instrumented hoof tester 600 may incorporate a pivot point 630 medially positioned along the arms 610, 620 in a plier-style configuration. By providing a lever design, the instrumented hoof tester 600 may mechanically amplify the user force component 642 applied by the operator to the handles 612, 622. For any given overall length of the instrumented hoof tester 600, longer handle 612, 622 lengths increase the applied force gain for the operator. For example, given 12-inch-long handles 612, 622 and an overall length of 16 to 17 inches for the instrumented hoof tester 600, the user force component 642 is approximately amplified by 2.5. The ideal handle 612, 622 dimensions may be balanced between ergonomics for the operator and the force application range required for the test subject and the field of use. For example, testing of equine and bovine hooves, a preferred length for the handles 612, 622 may range from 10-19 inches, enabling effective one- or two-handed use of the instrumented hoof tester 600 and achieving a suitable force application range (e.g., 0-150 pounds) while maintaining proper clearance between the first jaw 611 and the second jaw 621 to accommodate various hoof sizes (e.g., 4-8 inches). Accordingly, the exemplary plier-style configuration of the instrumented hoof tester 600 amplifies the squeezing force providing for sensitive hoof testing, with a user force component 642 gain tailored via pivotal leverage and handle 612, 622 length. The positioning of the pivotal connection at the pivot point 630 and the handles' 612, 622 lengths may be optimized for the force application range requirements and the shape, dimension and size of the test subject in any application.

While the exemplary embodiment focuses on hoof testing for bovine and equine test subjects, the instrumented hoof tester 600 and its advantageous measurement principles apply across many industries. As detailed above, potential applications and test subjects include, but not limited to, medical diagnostics, food science, manufacturing, other animal fields such as ovine, caprine and swine, metallurgy and mining, and archeology and paleontology. The instrumented hoof tester 600 advantageously enables digital quantitative mapping of tactile variables in any field requiring sensitive grasping and material manipulation. The instrumented hoof tester 600 exemplifies a universal platform to objectively measure gripped force across industries and use cases requiring precise haptic feedback and control. For example, the force-quantifying functionality of the instrumented hoof tester 600 provides objective tactile digital feedback for delicate gripping tasks. Further, the pivot point 630 may be positioned at the end of the arms 610, 620 to form a forceps-shaped design, which might be beneficial for applications that require reduced force and/or a few fingers to operate such that two-handed gripping might interfere with operation.

Both the first arm 610 and the second arm 620 may be independently or together form elastic members and/or beams that elastically deform when a squeezing force is applied by the user force components 642, advantageously creating an intrinsic design for the measuring module comprised of one or more force sensors 650, 651, 652, 653. The elastic deformation of the first arm 651 and/or the second arm 652 may act in symmetry with respect to each other such that each of their respective deformations may impact the jaws 611, 621 and/or the handles 612, 622. The one or more force sensors 650, 651, 652, 653 may be secured to the first arm 610 at various locations along the first arm 610, including portions on the first jaw 611 and the first handle 612. Similarly, force sensors 650, 651, 652, 653 may be secured to the second arm 620, while the force sensors are shown attached to the second handle 622 of the second arm 620 it may also be affixed to any portion of the second arm 620 including the second jaw 621. Any number of force sensors 650, 651, 652, 653 may be secured to the instrumented hoof tester 600 and placed on and/or in any portion of the instrumented hoof tester 600. As detailed herein, the force sensors 650, 651, 652, 653 may be secured to the arms 610, 620 such that each of the force sensors 650, 651, 652, 653 conform to the shape and the geometry of the arm 610, 620 to and/or in which each of the force sensors 650, 651, 652, 653 is affixed. Accordingly, the first arm 610 and the second arm 620, together or independently, may beneficially form a multifunctional elastic member and/or beam that provides loading, deformation and measurement scope functionalities for the instrumented hoof tester 600.

The clastic deformation of the first arm 610, the second arm 620, and/or both arms 610, 620 may be captured by one or more of the force sensors 650, 651, 652, 653, which may be formed of a piezoelectric material that intrinsically measures local loading for even minimal deformations. The first arm 610 and the second arm 620 may deform symmetrically with respect to each other such that both and/or either elastic deformation of the first arm 610 and/or the second arm 620 bends the one or more force sensors 650, 651, 652, 653 to measure the translated force components 644 generated via application of the user force components 642 to the handles 612, 622. Each force sensor 650, 651, 652, 653 may be composed of a flexible backing which supports a foil wire that may be thin metal wire arranged in a grid pattern (e.g., piezoelectric material composed of micro-electromechanical piezoresistive elements). The grid pattern extends the foil wire when subject to a deflection component 660, 661, 662, 663 that is transferred to the respective force sensor 650, 651, 652, 653 that conforms to the deformation of the arms 610, 620, causing a resistance change in each respective force sensor 650, 651, 652, 653 and obtaining accurate measurement of the translated force components 644 after proper calibration. The resistance changes across each of the one or more force sensors 650, 651, 652, 653 by bending the foil wire and flexible backing may be converted into electric voltage readings that represent the user force components 642 applied by the operator to the handles 612, 622 and generating the translated force components 644 applied to the test subject and/or the calibration block 670 as illustrated here held by the jaws 611, 621. The surface voltage variations on the one or more force sensors 650, 651, 652, 653 may be converted to units of force and displayed on a user module 681 of the controller 680.

After installation of each force sensor 650, 651, 652, 653 to the instrumented hoof tester 600, each force sensor 650, 651, 652, 653 will require independent calibration to properly convert the electric voltage generated by the force sensor into correlated calibrated values in a known unit such as pounds, kilograms, Newtons, etc. For the example, the calibration of the force sensors 650, 651, 652, 653 may be accomplished by comparing the voltage outputs generated by a specific force sensor 650, 651, 652, 653 to the translated force components 644 obtained by a calibration block 670 that includes a strain gauge. Which as detailed above is commonly available and pre-calibrated to the integral cantilever beam included in its design. Independent calibration of each of the force sensors 650, 651, 652, 653 may characterize their respective metrological response. By formulating known reference benchmarks by the calibration block 670, the voltage-to-force relationship for each of the force sensors 650, 651, 652, 653 may be independently digitally quantified. For example, controlled user force application 642 across the operating range requirements for a given application and test subject combined with ordinary least squares regression or other similar statistical technique formulates a sensitivity matrix that maps each of the force sensor's 650, 651, 652, 653 measurements to custom force vectors that represent the correlation of the respective deflection components 660, 661, 662, 663 to the translated force components 644 and/or user force components 642. Multivariate calibration utilized by the instrumented hoof tester 600 may beneficially incorporate temperature effects and the calibration fixture design of the instrumented hoof tester 600 may advantageously ensure proper user force application 642 and minimizes alignment errors for the one or more force sensors 650, 651, 652, 653. Accordingly, by formulating the composite calibration matrix via, for example, the calibration block 670, the instrumented hoof tester 600 may account for each of the force sensors' 650, 651, 652, 653 individual variances and may convert their measurements to a specific numerical value in known and understandable quantifiable units, such as pound, kilogram, Newton or another dimension. In addition, the calibration block 670 may provide routine recalibration of the one or more force sensors 650, 651, 652, 653 to beneficially mitigate drift and degradation over time. In-line monitoring of the instrumented hoof tester 600 may flag deviations from baseline performance for corrective recalibration of the force sensors 650, 651, 652, 653 to maintain, for example, measurement reliability and traceability. Statistically derived calibration models employing various mathematical and statistical techniques such as correlation tests, regression models, analysis of variance, analysis of covariance, chi-square, etc. may provide accurate conversions and correlations for the force sensors 650, 651, 652, 653 throughout the operating envelope of the instrumented hoof tester 600.

Each of the force sensors 650, 651, 652, 653 may be secured to the instrumented hoof tester 600 using a suitable adhesive, such as an epoxy, tape, glue, or other forms of attachment may be implemented to ensure the force sensors 650, 651, 652, 653 are secured to the arms 610, 620 of the instrumented hoof tester 600. For example, the force sensors 650, 651, 652, 653 may be secured to the arms using an adhesive with the same stiffness characteristics of the material used to construct the arms 610, 620, refining the bend of the force sensors 650, 651, 652, 653 to follow and conform to the deformation of the arms 610, 620 and improve the sensitivity of the force sensors 650, 651, 652, 653. The force sensors 650, 651, 652, 653 may be adhered to the instrumented hoof tester 600 using structural epoxies to match interfacial stiffness and strain transfer of the material of the arms 610, 620. For example, finite element co-simulations may inform adhesive selection for optimal stress distribution uniformity. Accordingly, the one or more force sensors 650, 651, 652, 653 may be secured onto and/or into the arms 610, 620 such that each of the one or more force sensors 650, 651, 652, 653 conforms to the shape and the geometry of the arms 610, 620, bending by a respective deflection component 660, 661, 662, 663 specific to each of the force sensors' 650, 651, 652, 653 placement. Moreover, the force sensors 650, 651, 652, 653 may be covered with a protective layer, which may be the same material as the adhesive or similar product, which will shield the force sensors 650, 651, 652, 653 from any potential damage. Conformal protective overmolding by the protective layer may advantageously distribute contact loads for optimal deformation conformity and electrically insulate the force sensors 650, 651, 652, 653 from external hazards. By way of example, rigid urethanes or elastomers may be employed for the adhesive to maximize mechanical coupling of the one or more force sensors 650, 651, 652, 653 to the instrumented hoof tester 600 while isolating the fragile components.

The force sensors 650, 651, 652, 653 may be affixed to the arms 610, 620 in any direction or orientation to capture different types of deformation, including, for example, axial, bending, shear and torsion, which may be either in the direction of compression or tension. Multiaxial implementation of the force sensors 650, 651, 652, 653 may characterize the multidirectional strain state of the instrumented hoof tester 600 with beneficial multidirectional sensitivity. The orientation and positioning of the force sensors 650, 651, 652, 653 on the arms 610, 620 may target locations on or in the arms 610, 620 that concentrate on axial, bending, shear, and torsional strain. Poisson effects may capture transverse strain response correlated to the applied longitudinal stresses, providing additional metrological insights into the composite material deformation of the instrumented hoof tester 600. Application of an axial force component will measure how the arms 610, 620 react when a user force component 642 is applied in the primary direction (i.e., parallel) of the handles 612, 622. Application of a bending force component will measure how the arms 610, 620 react when a user force component 642 is applied in a perpendicular direction to the primary direction of the handles 612, 622. In a preferred embodiment of the instrumented hoof tester 600, the translated force components 644 act in one direction such the material of the arms 610, 620 tends to expand or compress in the direction perpendicular to the user force components 642 applied to the handles 612, 622. The relationship between the longitudinal and transverse deformation of the arms 610, 620 under strain is known as the Poisson's effect.

By placing the force sensors 650, 651, 652, 653 in different orientations and locations along the arms 610, 620, the force sensors 650, 651, 652, 653 will advantageously measure various deformation types and/or magnitudes to capture a more granular picture of the user force components 642 applied to the handles 612, 622 and the translated force components 644 acting on the test subject. For example, placement and orientation of the force sensors 650, 651, 652, 653 may cause the force sensors 650, 651, 652, 653 to bend in various directions in response to respective deflection components 660, 661, 662, 663 acting in different directions with respect to the arms 610, 620. Location selection for each of the force sensors 650, 651, 652, 653 seeks to optimize force sensing sensitivity for a highly precise instrumented hoof tester 600, for example, by finding the weakest points along the arms 610, 620 where greatest deformation will occur. In addition, operator ease of use and other design factors are considered in determining locations for each of the force sensors 650, 651, 652, 653 on and/or in the arms 610, 620 in order to ensure that the instrumented hoof tester 600 provides simple operation that supports the specific requirements of the operator.

A controller 680 is electronically connected to one or more of the force sensors 650, 651, 652, 653. Either of the arms 610, 620 may be configured to fit and hold the controller 680 on the jaws 611, 621 and/or the handles 612, 622. The controller 680 may also be placed remotely by the operator away from instrumented hoof tester 600 and/or the testing area in general to protect the fragile components during the operating procedures. For example, the controller 600 may be held by an assistant to the operator or in the operator's pocket for safekeeping. The controller 600 includes, among other elements, a user module 681 and a protective case 682. The protective case 682 provides secure housing for all the modules and/or elements of the controller 680. The user module 681 may have the functionality to display the generated measurements to the operator; the user module 681 may include additional elements and features discussed in greater detail herein. The protective case 682 holds and shields all the various components and/or modules of the controller 680 as well as positions the user module 681 such that the measured forces are viewable by the operator while using the instrumented hoof tester 600.

The controller 680 may include female-end connection plugs 685, 686, 687, 688 to establish electronic connection with each of the force sensors 650, 651, 652, 653. Each of the attached force sensors 650, 651, 652, 653 may have a corresponding male-end connection plug 655, 656, 657, 658 that provides quick and weatherproof electronic connection means to the controller 680. Connecting one or more the female-end connection plugs 685, 686, 687, 688 with each corresponding male-end connection plugs 685, 686, 687, 688 may provide power to the force sensors 650, 651, 652, 653 as well as enable the force sensors 650, 651, 652, 653 to send the generated measurements for processing by the controller 680. Wires 690, 691, 692, 693, 695, 696, 697, 698 may be provided for each of the connection plugs 655, 656, 657, 658, 685, 686, 687, 688 allow for the controller 680 to be connected to the instrumented hoof tester 600 and its one or more force sensors 650, 651, 652, 653 while being positioned in a remote location. The length of each of the wires 690, 691, 692, 693, 695, 696, 697, 698 may vary, for example, from 3 to 48 inches, depending on the application of the instrumented hoof tester 600. The wires 690, 691, 692, 693, 695, 696, 697, 698 may be embedded into the instrumented hoof tester 600 and/or integrated as part of the instrumented hoof tester 600. Any number of force sensors 650, 651, 652, 653 may be connected to the controller 680 at any time. Accordingly, in case of malfunction of one of the force sensors 650, 651, 652, 653, the controller 680 may continue to operate with the other connected force sensors 650, 651, 652, 653. Quick connect and release connection plugs 655, 656, 657, 658, 685, 686, 687, 688 also advantageously offers a simple solution for removal of the controller 680 in order to perform sanitization and/or disinfection of the arms 610, 620, in particular the jaws 611, 621 that engage the test subject, of the instrumented hoof tester 600. Other means of connection between the force sensors 650, 651, 652, 653 and the controller 680 such as remote communications may also be implemented as discussed herein.

When in operation and squeezing the handles 612, 622 together, the controller 680 is equipped to receive, and process and analyze, among other functionalities, the measured translated force components 644 generated by the user force components 642 applied on the handles 612, 622. In particular, the force sensors 650, 651, 652, 653 bend in reaction to a respective deflection component 660, 661, 662, 663 generated by the shear forces translating through the material of the arms 610, 620, such that the force sensors 650, 651, 652, 653 bend to match and conform to the deformation of the shape and the geometry of the arms 610, 620. Because both the arms 610, 620 may deform in symmetry to each other, both the arms' 610, 620 deformations may bend the force sensors 650, 651, 652, 653 by their respective deflection components 660, 661, 662, 663 no matter the placement of the force sensors 650, 651, 652, 653 on the arms 610, 620. For example, when testing on hoofed animals such as cattle, horses, sheep, goats or other test subject, the operator squeezes the instrumented hoof tester 600 at various spots on the test subject's hoof. Applying increased user force components 642 (i.e., squeezing with greater force), until the operator reaches a maximum desired user force component 642, and/or the test subject retracts its limb in reaction to pain from the pressure created by the translated force component 644 applied to the test subject's hoof. For example, no retraction by the test subject may indicate the selected pointed tested by the instrumented hoof tester 600 on the test subject is not sensitive with no presence of pain or issue requiring treatment.

The instrumented hoof tester 600 may be able to withstand substantial user force components 642 (e.g., up to 250 pounds) applied by the operator and still maintain the arms' 610, 620 original shapes in the elastic region specific to their material selection upon the release of the user force components 642. The release of the user force components 642 applied to the handles 612, 622 may allow the arms 610, 620 and as a result the force sensors 650, 651, 652, 653 to return to their original shapes and thus may tare (i.e., zero) the force sensors 650, 651, 652, 653 given their respective calibrations based on their respective deflection components 660, 661, 662, 663. For example, arms 610, 620 constructed of stainless steel may require a profile dimension of at least 0.5 by 0.75 inches to ensure the arms 610, 620 do not extend past 250 pounds, which is outside the elastic region of stainless steel. Accordingly, a user force component 642 greater than 500 pounds would be in the plastic zone of stainless steel and may permanently deform the shape and/or the geometry of the arms 610, 620 resulting in potential erroneous measurements by the force sensors 650, 651, 652, 653. The controller 680 may display the measured translated force components 644 to the operator via the user module 681. Accordingly, the instrumented hoof tester 600 advantageously provides the operator with a specific numerical value in known standard quantifiable units such as pound, kilogram, Newton or other dimension.

For example, by digitally quantifying and knowing the applied user force components 642, the operator of the instrumented hoof tester 600 may easily calibrate their qualitative tactical findings during clinical evaluation of hoofed test subjects and better determine the health of the hoof and discover any areas of concern with respect to lesions, defects or other clinical issues. Digital quantification and display of the applied user force components 642 on the instrumented hoof tester 600 to its operator beneficially provides a quantitative measure of the translated force components 644 at which the test subject retracted its limb, where less sensitivity in the test subject will result in increased measured translated force components 644 and applied user force components 642. The instrumented hoof tester 600 may not only be used to inspect each limb and/or hoof of the test subject but also the instrumented hoof tester 600 may be utilized around different portions of each limb and/or hoof, testing all parts of the limb and/or the hoof (e.g., sole, interdigital zone and wall), in order to locate the exact problem spot and issue treatment. The instrumented hoof tester 600 may measure and display the generated squeezing user force components 642 and translated force components 644 for each test and/or use, advantageously assisting the operator to pinpoint various spots of concern on the test subject. Accordingly, the operator of the instrumented hoof tester 600 may be able to assess the level of severity of the lesion and objectively assess the level of pain. The smaller the force at which the test subject responds to the instrumented hoof tester 600 typically indicates a greater sensitivity to pain and/or a more severe lesion.

The exemplary embedded and/or integrated force sensor configuration of the instrumented hoof tester 600 offers greater flexibility in the design of the instrumented hoof tester 600 and forms an engagement path 640 at the ends of the jaws 611, 621 free of potential obstructions in order to not interfere with the operator's procedures with the test subject. By embedding and integrating the force sensors 650, 651, 652, 653 on the surface of the instrumented hoof tester or into the material itself, the instrumented hoof tester 600 advantageously leverages the arm's 610, 620 natural deformation characteristics to perform the force measurements without substantial modification or additional means for bending and interacting with the force sensors 650, 651, 652, 653. For example, the simplified design of the instrumented hoof tester 600 will provide for simplified manufacturing, assembly and maintenance as well as increase the longevity of the instrumented hoof tester 600 when exposed to regular use in harsh environments such as farms, barns and racetracks.

To optimize the performance and scope of uses for the instrumented hoof tester 600, the arms 610, 620 may be constructed to beneficially minimize the overall weight and volume of the instrumented hoof tester 600 in order to facilitate easy operability and portability for the operator. One exemplary technique to this design goal is via material selection of the arms 610, 620, additional examples of design techniques may be implemented as discussed herein. The arms 610, 620 of the instrumented hoof tester 600 may be constructed of any material, and this material selection may play a primary role in the accuracy of the measurements generated by the one or more force sensors 650, 651, 652, 653 embedded into and/or integrated onto the arms 610, 620 in order to take advantage of moldability of the instrumented hoof tester 600. The instrumented hoof tester 600 may be constructed of various materials, including but not limited, metal, steel, metallic alloys, composites, hybrids, or polymers, which each present different advantages considering the intended field of application. Lightweighting of the arms 610, 620 may focus on structural alloys such as precipitation-hardened aluminum or ultra-high-strength steels, which offer excellent strength-to-weight ratios. Selective reinforcement of the arms 610, 620 via, for example, composites or metal laminates may optimize stiffness of the design. In addition, polymers such as PEEK and thermoset composites may provide fatigue resilience combined with radiolucency to bolster potential visualization functionality for the instrumented hoof tester 600 as detailed herein.

Material choices for the instrumented hoof tester 600 may beneficially aim to balance durability, chemical resistance, and sensitivity needs. For example, 6000-series aluminum alloys offer superior corrosion resistance compared to steel in caustic environments. The lower Young's modulus of the material selected for the arms 610, 620 may also increase strain sensitivity. Analytical models coupled with strain simulation via FEA may inform multiphysics materials selection for the instrumented hoof tester 600. In addition, test articles may be utilized to validate design decisions and drive iterative improvements for the instrumented hoof tester 600. For example, based on the known stiffness of aluminum, construction of the arm using aluminum material would require less user force components 642 applied by the operator in comparison to other materials such as stainless steel in order to bend and deform the arms 610, 620 during operation. Accordingly, the material selection of the arms will advantageously maintain strength to guarantee proper measuring functionality while providing the necessary bend to allow for minimalistic design of the instrumented hoof tester 600.

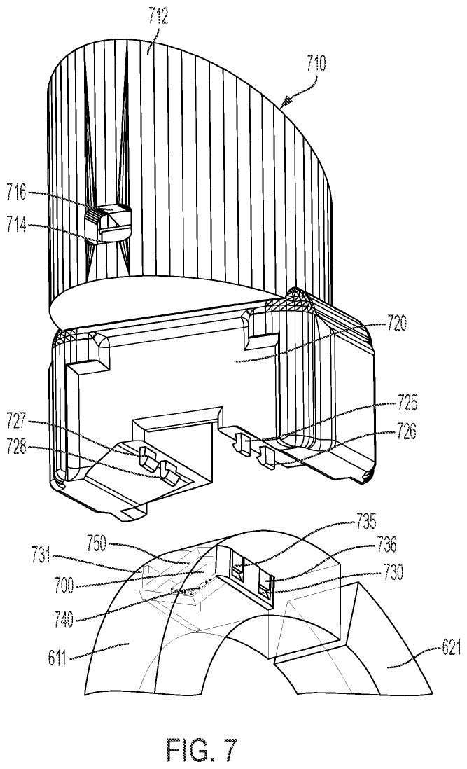

FIG. 7 illustrates another example of the instrumented hoof tester 600 having an embedded force sensor design. The first jaw 611 of the first arm 610 is shown in a transparent view to reveal the force sensor 700 embedded into the first jaw 611 of the first arm 610. The first jaw 611, corresponds to the first arm 610 (not fully illustrated), aligns with the second jaw 621, which corresponds to the second arm 620 (not fully shown), to engage a test subject between each of their respective distal ends.

The controller 710 may be composed of a protective case 712 to house and protect the processing module 714 and other modules as described herein, a charging port access 716, and a connection hub 718 to secure and fasten the controller 710 onto the arm of the instrumented hoof tester 600. The charging port access 716 may provide simple means for recharging and/or powering the power module of the controller 710. The charging port access 716 may be covered with a lid (not shown) when not being charged and/or powered to prevent dust or other debris from penetrating and potentially eroding the internal components of the controller 710.

Further, the protective case 712 of the controller 710 may not only serve to protect all the mechanical components from shock or other events that may cause mechanical damage, but also the protective case 712 may be weatherproofed and insulated to shield the controller 710 and its internal elements and/or modules such as the processing module 714 from the environment. For example, in the harsh environment of a dairy farm or horse barn, the instrumented hoof tester 600 may be exposed to numerous extreme conditions including drastic temperature changes as well as wet and dirty surroundings. Because of the instrumented hoof tester's 600 design, it will beneficially remain durable when facing these environmental conditions without issue or malfunction. In addition, a storage travel container may be provided to store components such as the controller 710 or other fragile components while not in use. The storage travel container may include an auxiliary battery to recharge the power module of the controller 710 while in storage. These beneficial protective techniques will help ensure the instrumented hoof tester 600 remains robust and incorporates into current operator and/or test subject routines for a wide range of fields.

A pair of mounting brackets 730, 731 may have a quick connect and release mechanism such as the snap fit mechanism, for example, via snap female ends 735, 736 shown on the mounting bracket 730 to attach the controller 710 and hold it in place during operation of the instrumented hoof tester 600. The connection hub 720 on the bottom of the controller 710 includes, among other elements, snap male ends 725, 726, 727, 728. Each of the snap male ends 725, 726, 727, 728 correspond and fit with snap female ends 735, 736 formed on each pair of mounting brackets 730, 731. The mounting bracket 731 may include snap females (not illustrated), as shown with the snap female ends 735, 736 of the mounting bracket 730, to correspond and fit with the snap male ends 725, 726, 727, 728 of the connection hub 720. The snap female ends 735, 736 and the snap male ends 725, 726, 727, 728 may fit securely together to complete assembly, which establishes both mechanical coupling and electronic connection between the controller 710 and the force sensor 700 as well as any other components embedded in and/or integrated on the instrumented hoof tester 600. The snap fit mechanism is only one exemplary means for fastening and securing the controller 710 to the instrumented hoof tester 600, other means to hold the controller 710 to the instrumented hoof tester 600 include but are not limited to pins, screws, bolts, hook and loop, clamps, clasps and clips or other similar means for repeatable securing and detaching of the controller 710 to the instrumented hoof tester 600. Each pair of mounting brackets 730, 731 may be machined directly into the jaws 611, 621 and/or affixed to the jaws 611, 621 on opposite sides of the first jaw 611 and/or the second jaw 621 in opposing pairs to provide structural support and security for the controller 710. For example, depending on the material used to construct the pairs of mounting brackets 730, 731, each pair of mounting brackets 730, 731 may be aligned and then attached to the jaws 611, 621 to the sides of the instrumented hoof tester 600 by means of an adhering, welding or mechanical fasteners such as rivets, hook and loop, clips, snaps, bolts, pins, screws, clasps, clamps, etc. Additional insulating materials may be provided around each of the mounting brackets 730, 731 along the surface flush with the arms 610, 620 of the instrumented hoof tester 600.

A cavity 750 may be provided along the profile of the first jaw 611 to accommodate a force sensor 700. The cavity 750 may be formed through the first arm 611 and/or the second arm 621 to embed the a force sensor 700 into the arms 610, 620. For example, the dimensions of the cavity 750 may be about 0.3 inches long, 0.2 inches wide and 0.001 inches thick to fit and accommodate a typically sized force sensor 700; however, the cavity 750 may be any size and/or dimensions that would be suitable for the instrumented hoof tester's 600 application as well to fit one or more force sensors 700 and/or other embedded components. The cavity 750 may be aligned with the location of the pair of mounting brackets 730, 731 to facilitate assembly of the force sensor 700 and the mounting brackets 730, 731 during manufacturing. Alternatively, the cavity 750 may be placed away from the mounting brackets 730, 731 at any location along the jaws 611, 621 and/or the handles 612, 622 of the instrumented hoof tester 600. Preferably, one or more force sensors 700 may each be fitted into a respective cavity 750 may be situated at different locations where the stresses on the instrumented hoof tester 600 are at their maximum. Based on the dimensions of the cavity 750, the cavity 750 may beneficially further thin the cross-section of the arms 610, 620 to weaken the attachment location of the force sensor 700 and generate elevated resultant strain. Proper placement and attachment of the force sensor 700 optimizes the measuring sensitivity and accuracy of the instrumented hoof tester 600, by namely maximizing resistance change across the force sensor 700. For example, one optimal location for the cavity 750 may be at the apex of a first jaw 611 having a curved shape and geometry, which will maximize the one or more force sensors 700 measuring accuracy. An adhesive 740 may be used such as an epoxy, tape, glue and/or other forms of attachment may be used to both attach the force sensor 700 to the interior surface of the first jaw 611 inside the cavity 750 as well as used to cover the force sensor 700 and fill-in the cavity 750 to protect and weatherproof the force sensor 700 and any other embedded components. The adhesive 740 beneficially secures the force sensor 700 inside the cavity 750 to further conform the force sensor 700 to the shape and the geometry of the cavity 750 and in turn the natural deformation of the arms 610, 620 of the instrumented hoof tester 600.

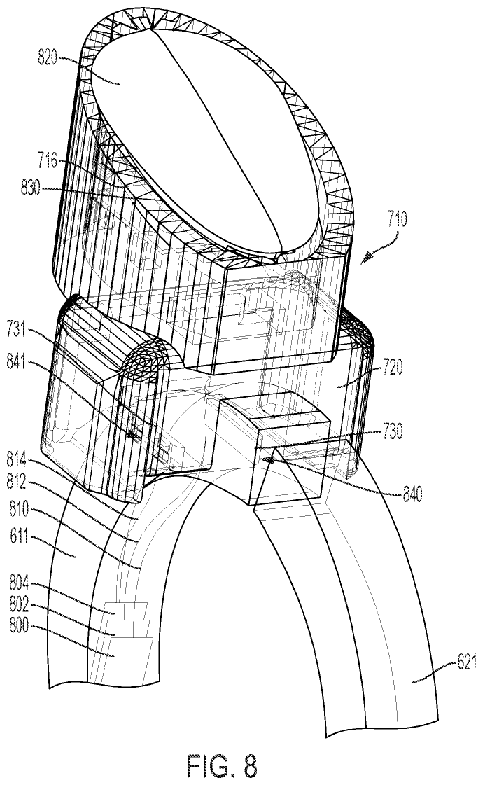

FIG. 8 shows another exemplary embodiment of an embedded sensor design with the controller 710 secured to one of the jaws 611, 621 of the instrumented hoof tester 600. For example, the first jaw 611 of a corresponding first arm 610 (partially illustrated) may be embedded with multiple force sensors 800, 802, 804 that are focused at a specific location in the first jaw 611 to provide multiple measurements for precise force measurement capabilities. Accordingly, the one or more force sensors 800, 802, 804 may be affixed at the same and/or different locations along the arms 610, 620 (partially illustrated) of the instrumented hoof tester 600, to increase measuring sensitivity, for example, by averaging the measurements from the multiple force sensors 800, 802, 804 in order to reduce error and potential failure.

The one or more force sensors 800, 802, 804 may be secured to different faces of the profile of the first jaw 611 such that, by way of example, the force sensor 800 may be in tension while the force sensors 802, 804 may be in compression. Strain may be measured on various faces and portions of the first jaw 611 and/or the first arm 610 with the implementation of multiple force sensors 800, 802, 804. The force measurements generated by the multiple force sensors 800, 802, 804 may be positive or negative because of the direction of stress being measured. However, the absolute value of these generated measurements from the one or more force sensors 800, 802, 804 may nonetheless be analyzed by the controller 710 together for better accuracy. The force sensors 800, 802, 804 may be embedded directly into the arm of the instrumented hoof tester by fashioning parallel cavities as detailed above along the sides of the first jaw 611. Each cavity may fit one of the force sensors 800, 802, 804 to stack the multiple force sensors 800, 802, 804 at one point of interest in the arms 610, 620 and/or to affix each of the force sensors 800, 802, 804 at different locations along the arms 610, 620 of the instrumented hoof tester 600.

As previously discussed, the embedded and/or integrated design of the instrumented hoof tester 600 may be optimized by specifying the location and placement of each force sensor 800, 802, 804. For example, placement of the force sensors 800, 802, 804 at the apex of the first jaw 611 that may be a curved shape may be used to tune the response of the instrumented hoof tester 600 to individual operator's needs and/or the test subject's size and dimensions. The apex of first jaw 611 having a curved-shaped is one illustration of a weak point in the exemplary plier-shaped design of the instrumented hoof tester 600 that may be leveraged for placements of the force sensors 800, 802, 804. Another example weak point on the arms 610, 620 of instrumented hoof tester 600 is portions of the jaws 611, 621 and handles 612, 622 adjacent to and/or near the pivot point 630. Accordingly, there are many suitable positions for the force sensors 800, 802, 804 to measure and capture the greatest inherent deformation of the arms 610, 620 of the instrumented hoof tester 600 and increase the accuracy of the force sensors 800, 802, 804 by maximizing the potential to measure the user force components 642 applied by the operator.

Each of the force sensors 800, 802, 804 may be affixed to the first jaw 611 using an adhesive, preferably the adhesive may have a stiffness coefficient matching the stiffness characteristics of the material used to construct the jaws 611, 621. For example, the adhesive may be an epoxy, tape, glue and/or other forms of attachment may be used to both secure each of the force sensors 800, 802, 804 into and/or onto the first jaw 611 as well as used to cover the force sensors 800, 802, 804 and fill-in their respective cavities to protect and weatherproof the embedded components including, for example, the electrical wires 810, 812, 814. Each of the force sensors 800, 802, 804 may be electronically connected to the mounting brackets 730, 731 via electrical wires 810, 812, 814. Each of the electrical wires 810, 812, 814 may run externally along the outside of the arms 610, 620 of the instrumented hoof tester 600 and/or be embedded into the arms 610, 620, partially or completely, of the instrumented hoof tester 600 in the same fashion as the force sensors 800, 802, 804. In an alternate exemplary embodiment of instrumented hoof tester 600, the arms 610, 620 of the instrumented hoof tester 600 may be formed of a hollow tubing as discussed herein. With a first jaw 611 constructed of a hollow tubing, the incorporation of the embedded force sensors 800, 802, 804 and electrical wires 810, 812, 814 may be achieved via an access cap as detailed herein. The addition of multiple force sensors 810, 812, 814 to the instrumented hoof tester 600 will not only increase measuring sensitivity but also advantageously expand the measuring range of the instrumented hoof tester 600.

The controller 710 may be secured to the first jaw 611 of the instrumented hoof tester 600 via the pair of mounting brackets 730, 731 fastening to the connection hub 720 of the controller 710, which also establishes the electronic connection between the force sensors 800, 802, 804 and the controller 710, as well as the modules housed in the controller 710, including but not limited to the user module 820 and the processing module 830. The snap fit design illustrated with the pair of mounting brackets 730, 731 and the connection hub 720 is one exemplary type of fasteners 840, 841 for securing and detaching the controller 710 to the first jaw 611; other fasteners 840, 841 include, but are not limited to, pins, screws, bolts, hook and loop, clasps, clamps and clips or other similar means for repeatable securing and detaching of the controller 710 to the first jaw 611. For example, the electrical wire 810, 812, 814 from each of the force sensors 800, 802, 804 connects to the pair of mounting brackets 730, 731 which in turn connects the force sensors 800, 802, 804 to the controller 710 when assembled. The measured translated force components 644 may be provided by the force sensors 800, 802, 804 to the controller 710 for processing and analysis, among other functionalities. The controller 710 may be configured to receive the measured translated force components 644 from the force sensors 800, 802, 804 to be processed by the processing module 830 programmed to implement instructions to execute various operations such as display of the measurements to the operator via the user module 820.

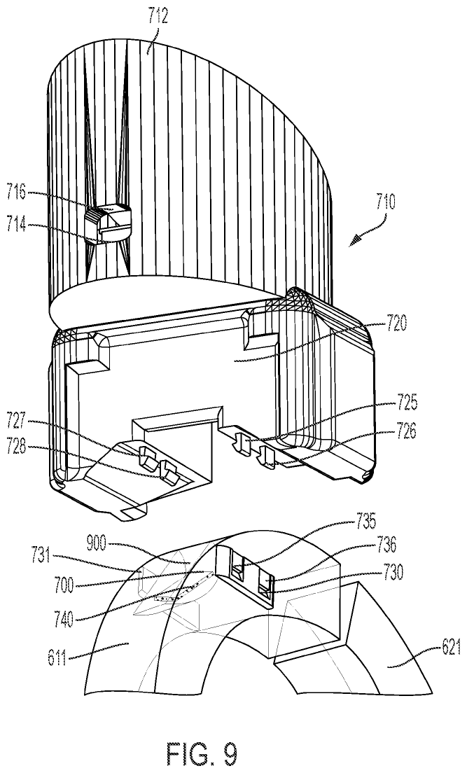

FIG. 9 depicts another exemplary embodiment of the instrumented hoof tester 600 having an integrated design for the force sensor 700 that provides a wedge 900 to increase the sensitivity of the measuring functionalities. In particular, the first jaw 611 of the instrumented hoof tester 600 may be modified and/or thinned to form the wedge 900 with dimensions to fit a force sensor 700. The thinning of the first jaw 611 may beneficially weaken the first arm 610 of the instrumented hoof tester 600 to allow greater deformation of the arms 610, 620 with less required applied user force components 642 to the handles 612, 622. The instrumented hoof tester 600 having a wedge 900 recessed into it may permit greater bend of the force sensor 700 to conform with the deformation of the first jaw 611 and generate refined more robust measurements of the translated force components 644 generated by the applied user force components 642. The controller 710 is shown disconnected from the instrumented hoof tester 600, revealing the snap male ends 725, 726, 727, 728 formed on the bottom of the connection hub 720 of the controller 710. The snap female ends 735, 736 on the pair of mounting brackets 730, 731 correspond with the snap male ends 725, 726, 727, 728 on the connection hub 720 to provide quick one-step release and connection of the controller 710. Simple connection of the controller 710 to the pair of mounting brackets 730, 731 creates a structural and electronic connection between the force sensor 700 and the controller 710 to receive the measurements provided by the force sensor 700 for processing and other functionalities.

The first jaw 611 of the instrumented hoof tester 600 may be configured to form a wedge 900 that houses the force sensor 700 and/or other components and provides tailored fitting such that the secured force sensor 700 may match with the shape and the geometry of the first jaw 611 and thus bolster the conformation of the force sensor 700 to the deformation of the arms 610, 620. The wedge may be constructed by thinning the arms 610, 620 at various attachment points to fit one or more force sensors 700. In embodiments of the instrumented hoof tester 600 employing multiple force sensors 700, several wedges 900 may be provided in the arms 610, 620 of the instrumented hoof tester 600 to fit and secure each of the force sensors 700 in independent locations on the instrumented hoof tester 600. The wedge 900 may be fashioned into the arms 610, 620 of the instrumented hoof tester 600 to form a rounded corner slot in order to reduce the cross-section profile of the arms 610, 620. The location of the wedge 900 may be anywhere along the arms 610, 620 of the instrumented hoof tester, including any portion of the jaws 611, 621 and/or the handles 612, 622. The force sensor 700 may be attached and protected with an adhesive 740 such as epoxy, tape, glue and/or other forms of attachment may be used to both secure the force sensor 700 onto the first jaw 611 as well as used to cover the force sensor 700 and fill-in the wedge 900 to protect and weatherproof the integrated components. The wedge's 900 surface where the force sensor 700 is to be adhered may be smoothed, dried and cleaned to avoid oxidation or pollution of the wedge's 900 surface in preparation for securing the force sensor 700 to the first jaw 611. Proper preparation of the wedge's 900 surface may advantageously improve the reliability of the measurements by the force sensor 700 and minimize errors from the force sensor 700. The adhesive 740 beneficially secures the force sensor 700 inside the wedge 900 to further conform the force sensor 700 to the shape and the geometry of the wedge 900 and in turn the natural deformation of the arms 610, 620 of the instrumented hoof tester 600.

The local shape and geometry at the wedge 900 may preferably be smooth and free of sharp edges to reduce the possibility of fatigue and unwanted stress accumulation. For example, the side profile dimensions of typical jaws 611, 621 of instrumented hoof tester 600 designed for equine and bovine applications are each approximately 0.4 to 0.75 inches to form a substantially rectangular or square shaped side profile for the jaws 611, 621. Considering these exemplary dimensions of the jaws 611, 621, the wedge 900 may be formed into the top and/or bottom surface of the first jaw 611 to a depth preferably ranging between 0.1 and 0.2 inches. The prismatic reduction of the first jaw 611 may optimize bend and sensitivity and, for example, keeping the width of the side profile of first jaw 611 constant may achieve a refined force application range and/or measuring capacity. For example, in consideration of the exemplary dimensions, the local geometry and shape modifications to the first jaw 611 with the wedge 900 may increase the force measuring range of the instrumented hoof tester 600 by more than a factor of 3.5.

The wedge 900 may be recessed in a perpendicular direction to the engagement path 640 of the instrumented hoof tester 600 such that the force sensor 700 may be oriented to be aligned with the shear deformation of the arms 610, 620 of the instrumented hoof tester 600 in order to measure the bending forces while in operation. Varying the shape and orientation of the cavity 900 may beneficially allow for measurement of deflection components 660, 661, 662, 663 in multiple directions and to capture different types of deformation.

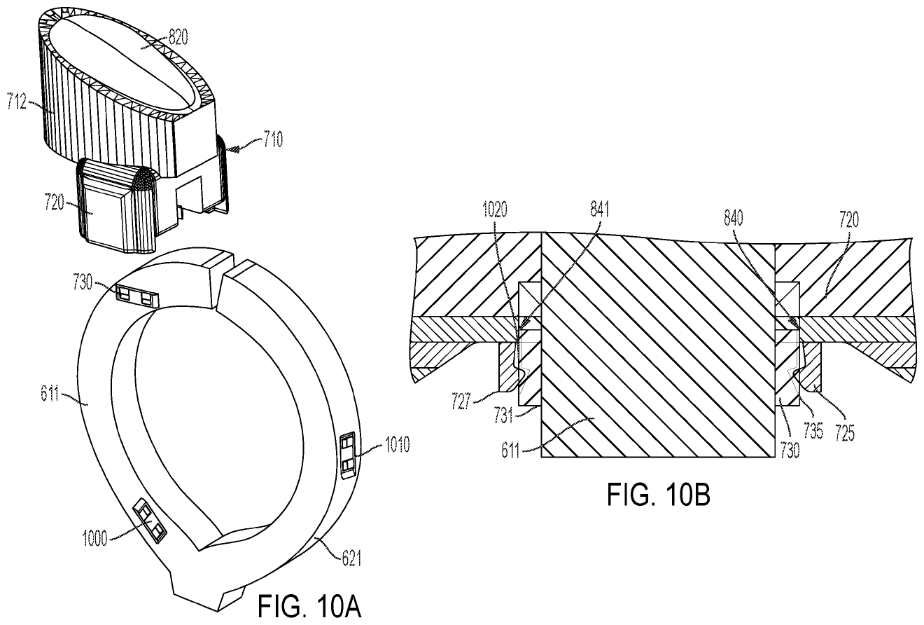

FIG. 10 (a) shows the jaws 611, 621 of an exemplary embodiment of the instrumented hoof tester 600 that allows attachment, detachment and reattachment of the controller 710 to multiple locations along the arms 610, 620 of the instrumented hoof tester 600. FIG. 10 (b) illustrates a detailed view of exemplary fasteners 840, 841 for a quick one-step attachment, detachment and reattachment mechanism.

The controller 710 is composed of a protective case 712 that securely houses the modules, including but not limited to the user module 820, and other internal components of the controller 710. The controller 710 may also be composed of a connection hub 720 to align and connect with the pair of mounting brackets 730, 731 or any pair of mounting brackets 1000, 1010 (which only show on mounting bracket of the respective pairs). Multiple pairs of mounting brackets 730, 731, 1000, 1010 may be affixed at various locations to the jaws 611, 621 or handles 612, 622 (not illustrated) of the arms 610, 620 of the instrumented hoof tester 600. One or more force sensors may be embedded into and/or integrated onto the jaws of the instrumented hoof tester as detailed herein. A force sensor may be positioned adjacent to each pair of mounting brackets 730, 731, 1000, 1010 to facilitate electronic connection of the force sensor to the controller 710 via each pair of mounting brackets 730, 731, 1000, 1010. Each pair of mounting brackets 730, 731, 1000, 1010 may be electronically connected to one or more of the embedded force sensors to maintain connection between the one or more force sensors and the controller 710 while positioning the controller 710 to any of pair of the mounting brackets 730, 731, 1000, 1010.

For example, the pair of mounting brackets 730, 731, 1000 are affixed to the first jaw 611 in order to orient the controller 710 in a parallel direction to the engagement path 640. In contrast, the pair of mounting brackets 1010 may be provided in the opposite direction affixed to the second jaw 621, allowing an operator to orient the controller 710 in a perpendicular direction to the engagement path 640. Depending on the application and field of use for the instrumented hoof tester 600, the operator may prefer viewing the user module 820 in various orientations and/or positions. The inclusion of multiple pairs of mounting brackets 730, 731, 1000, 1010 at different locations on the arms 610, 620 of the instrumented hoof tester 600 may advantageously permit an operator to easily select the most convenient position and orientation for the controller 710 while in operation and quickly attach the controller 710 to that selected position and orientation. Utilizing wireless communication capabilities as detailed herein, the controller 710 may also be placed remotely from the instrumented hoof tester 600 or anywhere along the arms 610, 620 including the handles 612, 622 and still be able to wirelessly connect and communicate with the one or more force sensors or other internal components embedded into and/or integrated onto the instrumented hoof tester 600.

Each pair of the mounting brackets 730, 731, 1000, 1010 may have snap female ends 735, 1020 to fit with the corresponding snap male ends 725, 727 formed on the connection hub 720 of the controller 710. The fastening of the snap male ends 725, 727 and the snap female ends 735, 1020 may establish both mechanical support and electronic connection between the controller 710 and the force sensors. The snap fit mechanism is one example of fasteners 840, 841 for quick one-step fastening and releasing of the controller 710 to the arms 610, 620 of the instrumented hoof tester 600. Other fasteners 840, 841 for simple securing and detaching of the controller 710 to and from any pair of mounting brackets 730, 731, 1000, 1010 include, but are not limited to, pins, screws, bolts, hook and loop, clamps, clasps and clips or other similar means for repeatable securing and detaching of the controller 710 to the arms 610, 620.

The controller 710 including the user module 820 and the other controller's modules may be secured to the instrumented hoof tester 600 or placed in a remote location. Maintaining electronic connection and communication of the controller 710 with the force sensors and/or other elements even if the controller 710 is placed in a remote location and physically detached from the instrumented hoof tester 600 may beneficially reduce the weight of the arms 610, 620 and widen the operator's view of the test subject held in the jaws 611, 621 to enhance ease of use for the operator. The exemplary integrated and/or embedded embodiments of the instrumented hoof tester 600 advantageously create a simple design with minimal moving parts and total number of parts overall, which simplifies manufacturing, assembly and maintenance as well as increases the durability of the instrumented hoof tester 600.

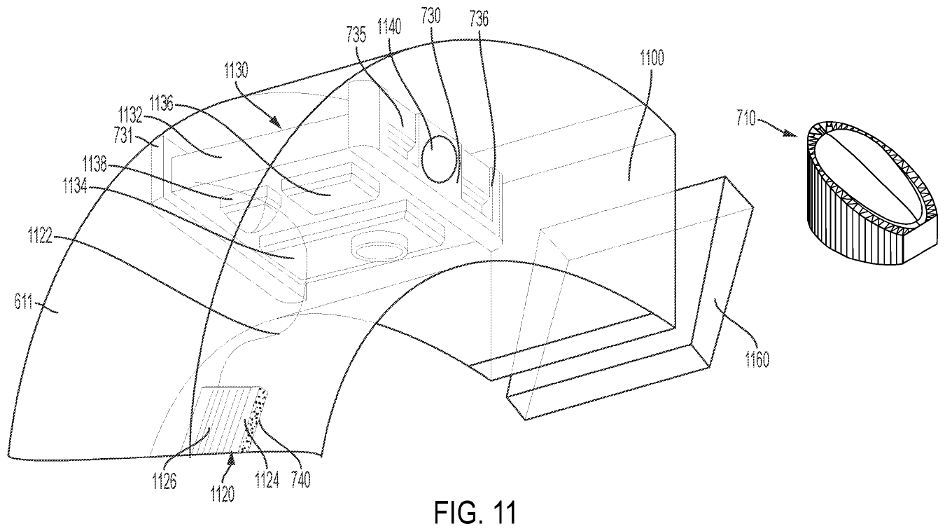

FIG. 11 depicts another exemplary embodiment of the instrumented hoof tester 600 having an embedded force sensor design that takes advantage of a hollow tubing 1100 to form the arms 610, 620 of the instrumented hoof tester 600. The first jaw 611 in FIG. 11 is shown to be transparent in order to reveal the housing of components inside the hollow tubing 1100, which beneficially encases the internal elements within the instrumented hoof tester 600 for secure and safe keeping. While only the first jaw 611 of the first arm 610 is illustrated in FIG. 11, the hollow tubing 1100 and all its associated benefits discussed herein may also be applicable to the first handle 612 as well as the second arm 620, and thus the second jaw 621 and the second arm 622.

The hollow tubing 1100 beneficially minimizes the overall mass of the instrumented hoof tester 600 while retaining structural stiffness to leverage the inherent elastic deformation of the first jaw 611 when subject to the applied user force components 642. The hollow tubing 1100 may be formed such that the side profile dimensions of the first jaw 611 utilizes an optimized diameter-to-thickness ratio in order to resist bending stresses and buckling. The hollow tubing 1100 of the first jaw 611 may advantageously provide a lightweight and high-strength design that maintains measurement accuracy for the force sensor 1120 by retaining deformation within the elastic range of the material selected to form the hollow tubing 1100. The hollow tubing 1100 may further provide a sealed internal housing within the first jaw 611 that beneficially enables protected component integration and weatherproofing. Analytical modeling and finite element analysis (FEA) may inform the shape and the geometry of the hollow tubing 1100 and thus the arms 610, 620 for given strength criteria, force application range, and materials. Validation via calibration testing utilizing, for example, the calibration block discussed herein may empirically verify the force-deflection profile for the force sensor 1120 and the desired clastic bending behavior for the instrumented hoof tester 600. The hollow tubing 1100 advantageously provides a instrumented hoof tester 600 with high strength-to-weight ratios, by combining analytical design and experimental verification to achieve robust and sensitive instrument response.

The first jaw 611 may include an onboard controller 1130 that is electronically connected to the controller 710 and communicates with the controller 710 to execute and complete all the functionalities of the instrumented hoof tester 600 as detailed herein. The onboard controller 1130 includes, among other elements, a mounting board 1132 to hold an onboard processing module 1134, an onboard power module 1136, and an onboard communications module 1138. All the modules detailed herein with respect to the controller 710 may also be included in the onboard controller 1130 and fitted to the mounting board 1132. The mounting board 1132 of the onboard controller 1130 may be secured to a pair of mounting brackets 730, 731 where the mounting board 1132 sits between each of the mounting brackets 730, 731. The first jaw 611, which may be formed entirely or partially of the hollow tubing 1100, includes, among other elements, a pair of mounting brackets 730, 731 to hold the controller 710 in a convenient location along the first arm 610 of the instrumented hoof tester 600. Each of the mounting brackets 730, 731 may have snap female ends 735, 736 for quick and easy one-step attachment, detachment and reattachment of the controller 710 to the first jaw 611 as detailed herein.

The communication and electronic connection between the onboard controller 1130 and the controller 710 may be mechanically established by fitting the controller 710 onto the pair of mounting brackets 730, 731 to electronically connect the controller 710 to the internal components housed in the hollow tubing 1100 of the first jaw 611. Alternatively, the onboard communications module 1138 may establish a wireless communication and connection between the onboard controller 1130 and the controller 710 in order to connect the internal components housed inside the hollow tubing 1100 of the first jaw 611 to the controller 710 placed in a remote location. Wireless communications and connection may be established via any of the various methods disclosed herein such as Bluetooth, Wi-Fi, NFC, Part 15 band, or ISM (LoRaWAN). Short-range wireless methods such as Bluetooth beneficially offer a low energy solution that enables reliable wireless communication and connection. The onboard communications module 1138 may incorporate antenna integration into the hollow tubing 1100 to facilitate transmissions between the various onboard and remote components across metal and/or composite portions of the instrumented hoof tester 600.

Incorporation of the onboard communications module 1138 as part of the internal housing of the first jaw 611 formed with a hollow tubing 1100 may also advantageously provide for pairing with auxiliary devices such as personal computers, electronic tablets, cellphones, printers and/or other similar computative devices to provide communication and connection between the auxiliary devices and the instrumented hoof tester 600. Paired auxiliary devices may utilize machine learning or other computing platforms for quantitative analysis and algorithmic processing of the forces measured by the force sensor 1120 to determine the status of the test subject, including, for example, characterization of hoof health and screening of potential pathologies in the hoof of the test subject. Moreover, the force sensor 1120 may incorporate internal wireless communication functionality utilizing, for example broadband piezoelectric force instruments, beneficially providing internal sending and receiving of data transmissions between the force sensor 1120, the controller 710 and/or onboard controller 1130 without the need for mechanical connection via an electrical wire 1122. Accordingly, the onboard controller 1130 and/or the embedded force sensor 1120 may advantageously leverage electrical engineering and material science principles for seamless measuring and data transmission.

The onboard controller 1130 may include a mounting board 1132 secured to the inner surfaces of the pair of mounting brackets 730, 731 such that the mounting board 1132 extends between the pair of mounting brackets 730, 731. For example, the onboard controller 1130 may include a miniaturized PCB layout to fit the various onboard modules and establish electrical coupling between all the components fitted to the mounting board 1132, such that the onboard controller 1130 may easily fit and be sealed within the hollow tubing 1100 of the first jaw 611. The force sensor 1120 may be electronically connected to the mounting board 1132 of the onboard controller 1130 via an electrical wire 1122 stretching through the hollowing tubing 1100 of the first jaw 611. Further, the pair of mounting brackets 730, 731 may incorporate a port 1140 that serves to connect the onboard controller 1130 and/or interface with all the components mounted to the mounting board 1132 such as the onboard power module 1136 which may require recharging. For example, the port 1140 may include, but limited to, a Universal Serial Bus (USB) or similar interface to provide simple means for operating and servicing the components housed in the hollow tubing 1100 such as powering and/or recharging the onboard power module 1136.

The onboard processing module 1134 may be programmed to work independently or in conjunction with the processing module housed in the controller 710 to execute all necessary instructions and functions to properly measure and display the translated force components 644 and the applied user force components 642, as well as the other functionalities detailed herein. For example, the onboard processing module 1134 may perform conversion of the measurements from the force sensor 1120 into understandable quantifiable units, such as pound, kilogram, Newton or another dimension to be displayed to the operator on the controller 710. The onboard power module 1136 mounted to the mounting board 1132 may power the onboard controller 1130 and permit for independent function of instrumented hoof tester 600 when the controller 710 is not in use and/or the operator is utilizing a paired auxiliary device to facilitate operation. In addition, the onboard power module 1136 may function as an auxiliary power source for the controller 710 to power the internal components of the controller 710 when attached to the first jaw 611 via the pair of mounting brackets 730, 731.

By utilizing one or more force sensors 1120, the instrumented hollow profile of the first jaw 611 advantageously enables modular force sensor integration for multi-axis digital deformation mapping. The force sensor 1120 may be adhered at any location inside the hollow tubing 1100 and/or to any of the external faces of the first jaw 611 depending on the type and the direction of deformation sought to be measured by the instrumented hoof tester 600. In one exemplary hollow design, the locations for securing multiple force sensors 1120 include portions of the arms 610, 620 that concentrate mechanical strains to amplify piezoresistive effects of the force sensors 1120. For example, finite element modeling may inform force sensor 1120 positioning inside the arms 610, 620 for optimal stress-strain response of the instrumented hoof tester 600.

The force sensor 1120 may be composed of a flexible backing 1124 which supports a foil wire 1126 that may be thin metal wire arranged in a grid pattern (e.g., piezoelectric material composed of micro-electromechanical piezoresistive elements). The grid pattern extends the foil wire 1126 when subject to a respective deflection component that is transferred to the force sensor 1120 that conforms to the deformation of the arms 610, 620, causing a resistance change in the force sensor 1120 and obtaining accurate measurement of the translated force components 644 after proper calibration. The resistance changes across each of the one or more force sensors 1120 by bending their respective foil wire 1126 and flexible backing 1124 may be converted into electric voltage readings that represent the user force components 642 applied by the operator to the test subject and/or a calibration block. The surface voltage variations may be converted to units of force and displayed on the controller 710.

An adhesive 740 used to attach each of the force sensors 1120 may be, for example, epoxy, tape, glue, but other forms of attachment may be implemented to ensure the force sensors 1120 are secured to and/or inside the arms 610, 620 of the instrumented hoof tester 600. Matching viscoelastic properties between the adhesive 740 used to secure the force sensor 1120 and the material used to construct the hollow tubing 1100 of the first jaw 611 beneficially improves flexural force transference of the instrumented hoof tester 600 to optimize conformation of the force sensor 1120 to the inherent deformation of the hollow tubing 1100 of the first jaw 611. One or more force sensors 1120 may be secured inside the hollow tubing 1100 of the first jaw 611 and connected to the mounting board 1132 and other electrical components via electrical wires 1122 stretching through the hollow tubing 1100. The electrical wire 1122 may be insulated and route along the neutral bending plane of the first jaw 611 to be shielded inside the hollow tubing 1100. Overmolding may be employed with the adhesive 740 and/or a secondary weatherproof adhesive such as an epoxy in order to fully encapsulate the force sensors 1120 and/or other internal components housed in the hollow tubing 1100 against environmental exposure during updates, maintenance and assembly. Accordingly, by optimizing the one or more force sensors' 1120 placement, adhesive properties, connection and communication functionality, electrical wire 1122 routing, and overmolding, the instrumented hoof tester 600 may advantageously have enhanced measurement fidelity even under challenging service conditions.

An access cap 1160 fitted on the end of the first jaw 611 may enable internal component interaction inside the hollow tubing 1100. The access cap 1160 may affix to the first jaw 611 via fasteners such as threads, pins, screws, bolts, hook and loop, clamps, clasps and clips or other similar means for repeatable securing and detaching of the access cap 1160 to the arms 610, 620 of the instrumented hoof tester 600. For example, the access cap 1160 may be threaded to fit with a threaded inside surface of the hollow tubing 1100 such that the access cap 1160 is configured to fit for simple entry to the interior of the first jaw 611. The access cap 1160 is configured to be reattachable in order to facilitate assembly and maintenance procedures by gaining entry to the components housed in the hollow tubing 1100 with removal of the access cap 1160. Securing and reattaching the access cap 1160 to the first jaw 611 seals the internal components, including, for example, the one or more force sensors 1120 and the onboard controller 1130 to protect them within the ruggedized housing of the hollow tubing 1100. As depicted here, the exterior profile of the access cap 1160 may be contoured to ergonomically grip and hold a test subject with the second jaw 621 (not illustrated). As previously mentioned, the hollow tubing 1100 may also form the first handle 612 and/or second handle 622 such that an access cap 1160 is provided at the end of the first handle 612 and/or the second handle 622 to seal the components housed within and enable easy and safe cleaning of the instrumented hoof tester 600. The access cap 1160 may be configured to ensure functionality-driven entry into the hollow tubing 1100 without compromising encapsulation integrity and/or exterior utility of the instrumented hoof tester 600. The detachable and reattachable access cap 1160 may beneficially provide selective entry into the interior of the arms 610, 620 for seamless upkeep, while shielding against harsh environmental exposure and enabling secure test subject gripping when utilized at the end of the jaws 611, 621.

While the hollow tubing 1100 of the first jaw 611 in FIG. 11 is depicted having a square shaped side profile, the side profile of the hollow tubing 1100 may be formed in any shape, for example, a circular shaped side profile may also be utilized for construction of the arms 610, 620, and thus corresponding jaws 611, 621 and handles 612, 622, of the instrumented hoof tester 600. By forming a hollow tubing 1100 with a substantially circular shaped side profile, the instrumented hoof tester may advantageously allow for more comfortable handles 612, 622 to hold by the operator.

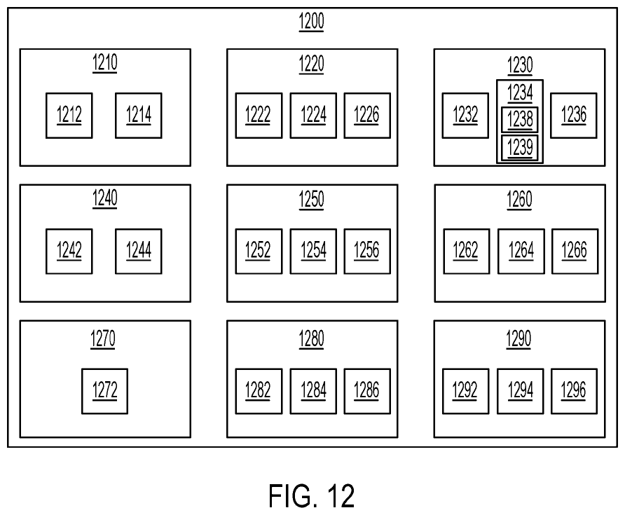

FIG. 12 depicts an exemplary embodiment of a controller 1200 designed for use with any of the exemplary embodiments of the instrumented hoof testers 100, 600 as described herein. All the functionalities and methodologies discussed with respect to controller 1200 apply to any of exemplary embodiments of the instrumented hoof testers 100, 600 as detailed herein.

The controller 1200 may include a variety of modules in order to execute and perform any functionalities and methodologies. For example, the controller 1200 includes a processing module 1210, a power module 1220, a user module 1230, a communications module 1240, a storage module 1250, a measuring module 1260, a test subject identification module 1270, an alert module 1280, and a hoof identification module 1290. As detailed above, the controller 1200 may include a protective case that may hold any or all the modules 1210, 1220, 1230, 1240, 1250, 1260, 1270, 1280, 1290 detailed herein and allows for simple attachment and detachability of the controller 1200 to and from the instrumented hoof testers 100, 600. Customizing the instrumentation of the controller 1200 with implementation of different modules 1210, 1220, 1230, 1240, 1250, 1260, 1270, 1280, 1290 that may be configured to be fitted to any part of the instrumented hoof testers 100, 600 or be located remotely advantageously optimizes the overall size and weight of the instrumented hoof testers 100, 600. Thus, the controller 1200 may beneficially permit significant design freedom to provide an ergonomic and user-friendly instrumented hoof testers 100, 600 suitable for many different types of operators, use cases and routines, among other benefits.

The power module 1220 may supply electrical power to the controller 1200 to facilitate each module's 1210, 1230, 1240, 1250, 1260, 1270, 1280, 1290 execution of their functionalities. The power module 1220 may include a battery 1222, which may be rechargeable or easily replaceable as needed, to provide the electrical power to the controller 1200. Alternatively, the power module 1220 may provide a plug 1224 for direct connection to an electrical power supply such as a standard electrical outlet. A switch 1226 may be provided as part of the power module 1220 to permit turning on and/or off the power supply 1220 and thus the controller 1200. For power management, the switch 1226 of the power module 1220 may serve as a back up to the activation buttons 1238 discussed in detail below with respect to the user module 1230.

The processing module 1210 may include a central processing unit (CPU) 1212 that electronically connects the modules 1210, 1220, 1230, 1240, 1250, 1260, 1270, 1280, 1290 together and serves as the primary support for performance and execution of instructions to complete system functionalities. For example, the processing module 1210 may be programmed to process and execute instructions to facilitate data transmissions sent by the measuring module 1260 to the user module 1230 for display of the measured translated force components 160, 644, among other functionalities. The processing module 1210 may further include means for module connection 1214 to enable interfacing between the various modules. For example, the processing module 1210 may utilize one or more Wheatstone bridge amplifiers as a means for module connection 1214 between the processing module 1210 and the measuring module 1260, in particular the one or more Wheatstone bridge amplifiers may connect the processing module 1210 to the one or more force sensors 1262 and/or strain gauges 1264 of the measuring module 1260. Quarter, half, and/or full-bridge topologies of the Wheatstone bridge amplifiers with piezoresistive active elements may advantageously provide temperature drift compensation for the measuring module 1260. Other modules 1220, 1230, 1240, 1250, 1270, 1280, 1290 may require similar means for module connection 1214 between the processing module 1210 and/or other modules 1220, 1230, 1240, 1250, 1270, 1280, 1290 in order to complete and execute necessary functionalities.

Configuration of the measuring module 1260 onto and/or into the arms 610, 620 of the instrumented hoof tester 600 beneficially allows parasitic Joule heating to dissipate through the arm's 610, 620 thermal mass. Convective circulation and/or Peltier elements may further enhance thermal regulation of the measuring module 1260 and/or other modules 1210, 1220, 1230, 1240, 1250, 1270, 1280, 1290. Depending on the placement, orientation and alignment of the measuring module 1260, the instrumented hoof tester 600 may be able to measure axial, bending, shear, and/or tensional forces. Moreover, the addition of one or more force sensors 1262 and/or strain gauges 1264 to the instrumented hoof tester 100, 600 may provide advantageous configurations to characterize multidimensional stress states. By selecting and conditioning the Wheatstone bridge amplifiers and/or any other means for module connection 1214, the measurement sensitivity and accuracy of the instrumented hoof tester 100, 600 may be optimized even under demanding municipal environments. For example, thermo-mechanical modeling may inform thermal management and creep mitigation for reliable processing and analytics by the controller 1200. Accordingly, precision connection and interfacing of the various modules 1210, 1220, 1230, 1240, 1250, 1260, 1270, 1280, 1290 may advantageously provide a controller 1200 with high-resolution digitization capabilities to analyze a test subject's subtle mechanical response.

The user module 1230 of the controller 1200 may include an output terminal 1232, input terminal 1234 and remote terminal 1236 in order to provide means for interfacing with the operator of the instrumented hoof testers 100, 600. The output terminal 1232 may display measurements from the measuring module 1260 and/or other data transmissions to the operator via a screen, such as light-emitting diodes (LEDs), liquid crystal displays (LCDs), or organic light-emitting diodes (OLEDs). For example, displayed data may include user's personal information, test subject's identification information, measurements of the translated force components 160, 644 representing the applied user force components 150, 642, test subject's status, and historical log files for both the operator and the test subject. The output terminal 1232 may hold display of any data transmissions until instructed to clear the display. By way of example, the measurements sent by the measuring module 1260 may be displayed and held on the screen of the output terminal 1232 until the operator triggers a tare (i.e., zeroing) function via the input terminal 1234. Alternatively, after each use of the instrumented hoof testers 100, 600 (i.e., application of squeezing pressure to the handles 112, 122, 612, 622) the output terminal 1232 may hold display of the measured force components 150, 160, 642, 644 for easy viewing by the operator, the display may be automatically zeroed or reset by the controller 1200 by continued use by the operator (i.e., repeated application and release of the squeezing pressure to the handles 112, 122, 612, 622). For example, the engagement trigger 190, 240 may return the elastic member 1266 of the measuring module 1260 to its original shape to tare the measuring module 1260 upon release of the applied user force components 150 to the handles 112, 122 of the instrumented hoof tester 100. In another example, the arms 610, 620 of the instrumented hoof tester 600 may serve as the elastic member 1266 of the measuring module 1260 to return the arms 610, 620 and the measuring module 1260 to their original shape upon release of the user force components 642 in order to tare the measuring module 1260.

The input terminal 1234 of the user module 1230 may include activation buttons 1238 for the operator to trigger and/or terminate various functionalities such as performing the tare/zero function of the measuring module 1260 and the power on/off function of the power module 1220. An operator may also be able to easily switch between distinct types of units (e.g., Newton to pounds to kilograms) of measurement at any time utilizing the activation buttons 1238, including for the last recorded measurements that has been held and displayed by the user module 1230 for easy and quick unit conversions. The input terminal 1234 may also include a touchscreen display to facilitate operator interaction and interfacing with the controller's 1200 functionalities and to advantageously integrate the input terminal 1234 with the output terminal 1232 into a single component. Further, the input terminal 1234 may include auxiliary ports 1239 to provide connection of and/or communication with auxiliary instruments such as a keyboard and a mouse to the controller 1200 and permit additional means of operator interaction with the instrumented hoof testers 100, 600. The auxiliary ports 1239 of the input terminal 1239 may be provided in addition to or in combination with the various ports 1242 provided as part of the communications module 1240 detailed below.

Moreover, the user module 1230 may include or be entirely composed of a remote terminal 1236. For example, the remote terminal 1236 may include the input terminal 1234 and output terminal 12323 that are easily detachable and/or be entirely composed of an auxiliary device such as a personal computer, an electronic tablet, a cellphone, a printer and/or other similar computative device. The components of the auxiliary device and the controller 1200 may beneficially function in tandem to reduce the number of components, required storage space and processing time as well as other benefits for the instrumented hoof testers 100, 600, enhancing user operability and overall performance of the instrumented hoof testers 100, 600 and the controller 1200. Depending on the field of use and operation of the instrumented hoof testers 100, 600, the operator may advantageously place the remote terminal 1236 of the user module 1230 away from the instrumented hoof tester 100, 600 for safekeeping during use and/or the operator may prefer to directly attach or mount the remote terminal 1236 and/or auxiliary device to the instrumented hoof tester 100, 600. For example, the user module 1230 of the controller 1200 may be oriented in any manner and placed on the jaws 111, 121, 611, 621 or handles 112, 122, 612, 622 to best suit the operator.

A communications module 1240 may be included in the controller 1200 to provide and establish all direct and/or wireless communications between the various modules 1210, 1220, 1230, 1250, 1260, 1270, 1280, 1290 of the controller 1200, any auxiliary devices and/or any auxiliary instruments. The communications module 1240 may include several types of ports 1242 such as universal serial bus (USB), local area network (LAN), ethernet or other similar means for interfacing communication between the controller's 1200 modules 1210, 1220, 1230, 1250, 1260, 1270, 1280, 1290, auxiliary devices and/or auxiliary instruments. In addition, the communications module 1240 may include means for wireless communications and networking 1244 such as Wi-Fi, Bluetooth, LoRa, cellular, radio frequency, satellite or other similar means for wireless communication. Wireless connectivity of the controller 1200 beneficially allows remote control and data transfer, among other benefits. The communications module 1240 may beneficially work with the processing module 1210 to complete and execute instructions for performance of the controller's 1200 functionalities as detailed herein. For example, the communications module 1240 may facilitate performance of the charging or supplying of power to the power module 1220, communicating with and/or connecting to a remote terminal 1236 of the user module 1230, and displaying, processing, receiving, analyzing, sending, storing, and/or printing measurements sent by the measuring module 1260 and/or other data stored in the storage module 1250. Accordingly, the communication module 1240 may advantageously offer seamless wired and/or wireless communication to enable versatile use cases and integration of the controller 1200 and the instrumented hoof tester 100, 600 to any application or field. For example, means for wireless communications and networking 1244 and the ability to pair the controller 1200 with auxiliary devices such as personal computers, electronic tablets, cellphones, printers and/or other similar computative devices permits easy data offloading and remote monitoring, as well as may enhance portability of the instrumented hoof tester 100, 600.

The measuring module 1260 of the controller 1200 may include various types and configurations of means for measuring components of tension, compression, pressure, or torque with respect to the forces, stresses and strains applied by an operator of the instrumented hoof tester 100, 600. For example, bonded metallic strain gauges 1264 and/or microelectromechanical force sensors 1262 transduce mechanical deformation into resistive signatures that represent the translated force components 160, 644 applied to the test subject. The measuring module 1260 may include strain gauges 1264 and/or force sensors 1262, as well as an elastic member 1266. The force sensors 1262 of the measuring module 1260 may incorporate a piezoresistive flexible material for digital quantitative stress-strain analysis.

As detailed above, a strain gauge 1264 in general consists of a force sensor 1262 epoxied to the bottom of its base and an elastic member 1266 in the shape of a cantilever beam formed at the top of the strain gauge. A strain gauge 1264 may be made of metal or other suitable material to ensure sturdiness but also provides the required elasticity of the elastic member 1266 (i.e., cantilever beam) and the base of the strain gauge 1264. When force, pressure, stress or strain is exerted on the strain gauge 1264, the clastic member 1266 (i.e., cantilever beam) may deform even slightly causing the epoxied force sensor 1262 to also bend, and except if overloaded the elastic member 1266 (i.e., cantilever beam) and the force sensor 1262 will return to their original shape upon the release of the applied user force components 150, 642. Instrumented elastic members 1266 like the cantilever beam formed on the strain gauge 1264 beneficially concentrate and modulate strains for sensitive detection through analog front-end amplification via, for example, resistive Wheatstone bridge amplifiers, that conditions measurements prior to digitization and/or processing by the controller 1200.

Alternatively, as detailed above, the measuring module 1260 of an instrumented hoof tester 600 may be configured with one or more force sensors 1262 directly attached to the arms 610, 620 of the instrumented hoof tester 600. For example, monolithically embedding and/or integrating the one or more force sensors 1262 directly onto and/or into the load-bearing compliant structures replaces discrete elastic mediators with distributed parameter measurements, advantageously enabling holistic deformation digital mapping by the measuring module 1260 under both static and dynamic excitation. By optimizing the materials selection, measuring capacity factor, and electromechanical modeling for the measuring module 1260, measurement resolution and noise rejection may be enhanced. Standardized calibration procedures as detailed herein that reference benchmarks generated by a calibration block 670 to trace and correlate measurements by the measuring module 1260 into standardized units with quantification of uncertainties. Accordingly, by coupling analytical and empirical techniques for the measuring module 1260, the instrumented hoof tester 600 advantageously provides intelligent instrumentation for precision biomechanical metrology.

The amount of resistive change measured by each of the force sensors 1262 of the measuring module 1260 may be converted by the processing module 1210 into readable and understandable units such as Newton, pound or kilogram or other dimension to be displayed via the user module 1230. As with the strain gauges 1264, the elasticity of the arms 610, 620 of the instrumented hoof tester 600 allows the arms 610, 620 and attached force sensors 1262 to return to their original shape when the applied user force component 642 is released from the handles 612, 622. During operation of the instrumented hoof testers 100, 600, the applied user force components 150, 642 may fluctuate, and the entire resistive signature generated by the measuring module 1260 may be recorded and stored in the storage module 1250 for later analysis. Alternatively, the measuring module 1260 may further include auto-capturing capabilities to address data fluctuation issues, beneficially highlighting measurements of interest, for example, by holding the maximum measurement generated for each use of the instrumented hoof tester 100, 600. For example, the user module 1230 may hold the maximum measurement generated by the measuring module 1260 for display after each use is completed such that the maximum reading or other measurements of interest may be manually noted by the operator even after the applied user force components 150, 642 are released by the operator. Further, the user module 1230 may show results from multiple uses or tests (e.g., past ‘n’ number of tests where ‘n’ can be anywhere between the immediate previous test to the number of previous tests the operator wants to perform) on the output terminal 1232 to allow simple comparison and/or averaging of different uses or tests, for example, to properly evaluate the same hoof or limb of a test subject. Any held displayed data on the output terminal 1232 may tared or cleared by manual and/or automatic action as detailed above.

In addition, the measuring module 1260 may have a controlled force application range with a limited measuring capacity (e.g., of about 200-250 pounds in equine and bovine applications) such that if the operator exceeds this limited measuring capacity an error message may appear on the output terminal 1232 of the user module 1230. In addition, the alert module 1280 may also provide a signal to the operator as detailed below to warn the operator that an overload is in progress. The limited measuring capacity prevents the operator from hurting the test subject with application of unnecessary amounts of force to the test subject that may potentially cause discomfort, pain or injury to even a sound test subject. Additionally, the controlled force application range may act to protect the sensitive and fragile components of the controller 1200 and the instrumented hoof tester 100, 600 in general from damage or overloading. The predetermined thresholds for the controlled force application range may be optimized based on the target application and/or the size and dimensions of the test subject. For example, test subjects such as ovine, caprine, or swine with smaller hoof sizes compared to bovine and equine may require reduced predetermined maximum thresholds (e.g., under 100 pounds) to ensure that both the operator and the test subject remain safe and comfortable during operation of the instrumented hoof tester 100, 600. The predetermined thresholds of the measuring module 1260 may be configurable via software updates to the controller 1200, offering the flexibility to tune the instrumented hoof tester 100, 600 enables wide-ranging capabilities to adapt across various applications, including, but not limited to, different veterinary disciplines and animal types. By utilizing a programmable approach to the controller 1200 and its modules 1210, 1220, 1230, 1240, 1250, 1260, 1270, 1280, 1290, advantageously future-proofs the instrumented hoof tester 100, 600 as current use-specific procedures and needs evolve, and new uses emerge.

The storage module 1250 may include a removable storage 1252, which may take the form, for example, of a Secure Digital (SD) card, USB pen, or other external hard drive, and/or an internal storage 1254 such as an internal hard drive, providing both external and internal memory capacity for the controller 1200. The storage module 1250 may also be connected to a network to access remote storage 1256, utilizing the means for wireless communications and networking 1244 of the communications module 1240 to access the auxiliary memory capacity of the remote storage 1256. Utilizing the versatile memory capacity of the storage module 1250, future improvements such as inclusion of additional features may be advantageously accomplished merely via software updates to easily address future issues and/or bolster the performance of the instrumented hoof tester 100, 600, by, for example, updated scoring protocols as detailed herein. The storage module 1250 manages and organizes all the force measurements, data transmissions and any other information collected by and stored in the controller 1200 of the instrumented hoof tester 100, 600. During operation, each use and/or squeeze of the instrumented hoof tester 100, 600 that generates data from the measuring module 1260 may be stored in the storage module 1250.

The processing module 1210 may utilize the storage module 1250 to facilitate processing and execution of functionalities in order to enable robust analytics and error mitigation. Statistical and mathematical techniques such as rolling averages and outlier rejection may be employed as part of the processing and analysis by the controller 1200 to improve data fidelity. Incorporation of calibration techniques, including, but not limited to, sensor fusion algorithms that correlate the force sensors' 1262 placement geometries and the elastic member's 1266 deformation patterns to transform voltage readings generated by the measuring module 1260 into force units using matrix calibrations stored in the storage module 1250. For example, a measuring module 1260 configuration using multi-sensor fusion with distances (di) and a sensitivity matrix (Si) for each of the respective force sensors 1262 may map voltages (Vi) into multi-axis force vectors (Fi) via the affine correlation formulation represented as Fi=Si*Vi. The storage module 1250 may store longitudinal log files for test subjects to beneficially collate measurements generated by the instrumented hoof tester 100, 600 over time. Hoof-specific identifiers stored in the storage module 1250 may track limb status individually in addition to the identification information for a specific hoofed test subject, offering granular analysis for various test subjects by the controller 1200. By performing analysis of the historical log files for time-based comparison, the controller 1200 may be able to uncover response trends and asymmetries as well as monitor the status of individual test subjects over time. The storage module 1250 and the processing module 1210 may advantageously leverage statistical, geometrical and time-series techniques to extract germane analysis into the status of the test subject such as clinically relevant hoof biomechanical insights in order to derive actionable data from raw voltage measurements generated by the measuring module 1260.

The performance of the instrumented hoof tester 100, 600 may be further optimized to the individual test subject by incorporating species and/or breed specific scoring protocols to enhance functionality. The test subject's scoring protocols may be based on, for example, breed, age, and weight or other data inputted by the operator into the user module 1230 in order to configure the digital mapping and comparison of the measurements generated by the measuring module 1260 to established industry standards and/or the operator's observations and experience. For example, standardized veterinary scales for assessing lameness in equine and bovine test subjects based on lameness grades on a numerical scale may be incorporated into the controller 1200 as part of the scoring protocols to facilitate automated pathology screening based on specific biomechanics of the test subject. By comparing the measurements of the instrumented hoof tester 100, 600 to the scoring protocols, the controller 1200 may trigger alerts via the alert module 1280 when measurements indicate deviations from a sound status for the test subject. Finite element analysis (FEA) and/or other modeling methods may simulate a status of the test subject such as presence of a lesion and/or navicular disease to derive scoring protocols. Machine learning classification algorithms and/or other analytical techniques may compare real-time measurements from the instrumented hoof tester 100, 600 to the simulated status to detect and stage pathologies, among other benefits. Individual test subject focused modeling, calibration, and analytics advantageously extract meaningful insights about the status of the test subject from the measuring module's 1260 measurements. By combining the functions of the controller 1200 with scoring protocols that, for example, encapsulate industry best practices such as veterinarians, the instrumented hoof tester 100, 600 may advantageously achieve systematized operational procedures such as automated lameness detection optimized for horses and cows with a trivial learning curve for easy use.

The stored scoring protocols may help guide the operator during operation with comparison of applied user force components 150, 642 and the translated forces components 160, 644 to the range of forces known to correspond with the standard industry scoring scale. For example, it may be established that over 120 pounds of applied force by the operator of the instrumented hoof tester 100, 600 is seen as a sound bovine test subject and thus the alert module 1280 may signal that the bovine test subject is determined to be healthy or sound when more than 120 pounds was applied during operation. Similar scoring protocols may be established for a wide range of test subjects and be employed by the instrumented hoof tester 100, 600. In accordance with such scoring protocol functionalities, an alert module 1280 may also be included in the controller 1200 of the instrumented hoof tester 100, 600. The alert module 1280 may send a signal and/or alarm to the operator, for example, when a problem area is detected (e.g., the applied force falls in the range of a lame scoring protocol). Accordingly, even an untrained operator may learn how to use the instrumented hoof tester 100, 600 very quickly and without the need for expert training.

The signal or alarm generated by the alert module 1280 may take the form of a visual indication 1282 (e.g., message display, flashing light), an audio indication 1284 (e.g., beeping sound from a speaker), and/or tactical indication 1286 (e.g., vibration of the handles of instrumented hoof tester). Moreover, the alert module 1280 may indicate a true/false result (e.g., sound or lame), and/or the alert module 1280 may also indicate the level of severity (e.g., 0-5 score for equine and/or 1-5 score for bovine) based on the established industry standards such as lameness scoring scales. For example, when the forces read by the measuring module 1260 are found to correspond to a lame test subject based on the test subject's historical log file and/or the established custom scoring protocols, the signal provided to the operator by the alert module 1280 may include the level of severity (e.g., mildly lame, lame, and severely lame) of the test subject. The alert module 1280 may beneficially ensure that the operator is aware of the problem and thus able to take immediate and hopefully preventative action.

The instrumented hoof tester 100, 600 may also be calibrated to a specific operator by inputting several personal calibration factors such as gender, age, etc. specific to the operator. The operator's personal calibration factors may be inputted by the operator via the input terminal 1234 of the user module 1230. The storage module 1250 may store the operator's personal calibration factors for reference in future operation. In-situ personal calibration procedures may characterize the instrumented hoof testers' 100, 600 response for individual operators. Maximum voluntary contraction tests that correlate to known force benchmarks may quantify individual operator's grip strength variance and calibrate the instrumented hoof tester 100, 600 accordingly. A calibration block 670 as detailed herein and/or digital test frames with traceable piezoelectric force sensors 1262 may formulate the standardized force benchmarks for the translated force components 644 for baselining of the measuring module 1260. The calibration block 670 advantageously provides a method to overcome the vulnerabilities of the force sensors 1262 to temperature variances and avoid accuracy issues. A software routine stored in the storage module 1250 may guide operators through reproducible personal calibration protocols. Real-time sensor drift correction and fatigue compensation via the operator's personal calibration protocols may maintain measurement veracity over extensive regimes to increase the durability of the instrumented hoof tester 100, 600. Periodic automated recalibration of the instrumented hoof tester 100, 600 may beneficially mitigate variability from changing operators, test subjects and environmental conditions. For example, the operator's personal calibration protocols compensate for an operator with below average strength and/or an operator who is physically tired that day to recalibrate the comparisons of current measurements generated by the measuring module 1260 to stored log files and scoring protocols. In summary, structured calibration workflows calibrated against instrumented benchmarks may advantageously enable reliable personalized force quantification for each operator of the instrumented hoof tester 100, 600. The robust force sensing design and in-field validation procedures of the instrumented hoof tester 100, 600 may ensure reproducible and accurate results across operators, test subjects, test sessions, and contexts.

With the ability to store data by the storage module 1250, the controller 1200 beneficially allows for valuable logging functionality and creation of log files for individual test subjects as part of the instrumented hoof tester's 100, 600 abilities. A test subject's identification information along with logistical data such as a timestamp and a location (e.g., name of farm, track, training center, rehabilitation facility, etc.), as well as personal information about the operator may be stored in the storage module 1250 for later reference. The collection of the data may be done either manually by the operator's input via the input terminal 1234 of the user module 1230 or automatically via, for example, the test subject identification module 1270 and/or hoof identification module 1290.

With respect to automated means of data collection, most test subjects such as equine and bovine are required by law or it is common industry practice to be tracked via radio frequency identification (RFID) tags in order to ensure biosecurity. The RFID reader and antenna 1272 of the test subject identification module 1270 is designed to read information stored on each test subject's corresponding RFID tags, which is physically attached to the test subject, and communicate this information for storage in the storage module 1250. Thus, with inclusion of a RFID reader and antenna 1272 in the test subject identification module 1270, a test subject's RFID tag may be easily scanned in order to automatically capture and store all necessary identification and logistical data associated with the test subject under examination. In general, the RFID reader and antenna 1272 may have a range of up to approximately 23 feet which suits the intimate nature of a hoof testing procedures and the proximity to the test subject is already required by the operator in order to perform a standard hoof testing procedure. The RFID reader and antenna 1272 may also be advantageous to various other fields that utilize similar technology for tracking test subjects.

A hoof identification module 1290 may be provided as part of the controller 1200 in order to differentiate between the specific hoofs under testing. The hoof identification (e.g., front-left, front-right, hind-left, hind-right) may be accomplished manually by the operator via the user module 1230. For example, the operator may use the activation buttons 1238 on the input terminal 1234 to indicate which hoof is to be tested. Alternatively, the hoof identification module 1290 may include a dial 1292 that is composed of at least four positions corresponding to each hoof (e.g., fore-right, fore-left, hind-right and hind-left), the dial 1292 may be turned by the operator as the hoof testing moves to a different hoof. Alternatively, the hoof identification module 1290 may follow an automated set routine 1294 that prompts the operator via the user module 1230 which hoof should be tested, automatically prompts a different hoof after completion of testing, and continues to switch prompts until all the hoofs are tested. The granular identification offered by the hoof identification module 1290 may also be advantageous to various other fields that require specification within the test subject itself.

The hoof identification module 1290 may also be done automatically, for example, by utilizing the test subject identification module 1270 to trigger the RFID reader and antenna 1272 at the start of each use or test and calculating the processing time in order to determine the instrumented hoof tester's 100, 600 distance away from the test subject's RFID tag. In general, a bovine test subject will have RFID tags attached to their ears and equine test subject may have the RFID tag implanted in their jawline. The hoof identification module 1290 may automatically detect hoof and/or limb positions by leveraging RFID proximity relative to the instrumented hoof tester 100, 600. For example, associating a bovine's ear RFID tag with precise time-of-flight distances may localize the instrumented hoof tester 100, 600 relative to anatomy of the test subject via trilateration. The hoof identification module 1290 not only provides means for distinguishing between the hoofs, limbs or other part of the test subject but also a visualization member 1296 may be employed such as a LiDAR Scanner, video camera, photographic camera, radiographs or ultrasound technology to assist the hoof identification module 1290. The visualization member 1296 may also add benefits of scanning and/or imaging providing additional tools for analysis and reference for diagnosing any potential problems with the test subject. By integrating radio frequency and optical visualization techniques, the controller 1200 may reliably segment, for example, fore/hind and left/right limbs for precise hoof diagnoses. The unified coordinated framework of the hoof identification module 1290 also advantageously enables building full three-dimensional digital models of the test subject with detailed shape and deformation quantifications.

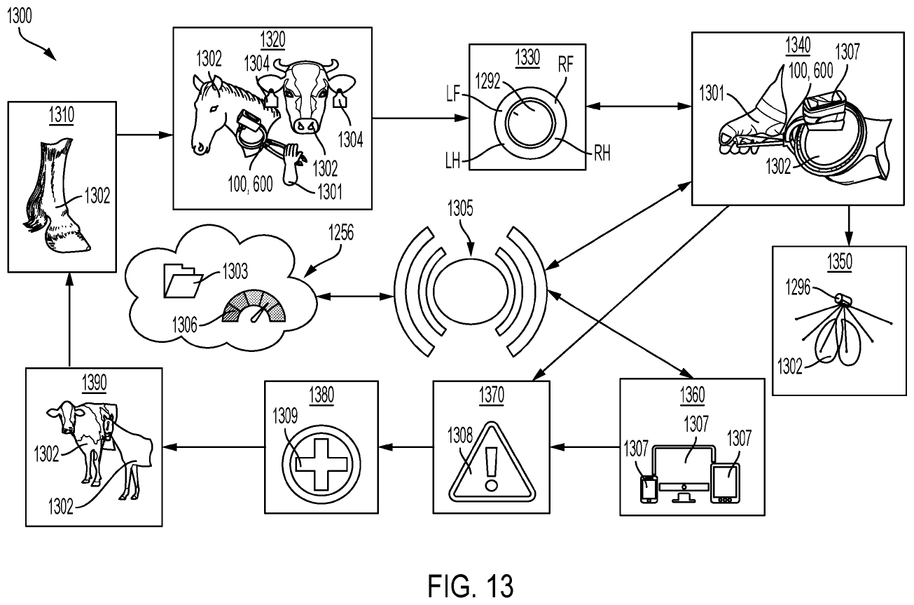

FIG. 13 illustrates an exemplary methodology for general operation 1300 of the instrumented hoof tester 100, 600 to reveal the novel system of use. While FIG. 13 shows an exemplary methodology for general operation 1300 of equine and bovine test subjects, the instrumented hoof tester 100, 600 may be utilized for a wide range of various applications such as medical diagnostics to provide palpation and tactile examination of human anatomy (e.g., musculoskeletal, dermatological, etc.); food science to enable precise digital mapping of tactile properties such as softness, ripeness, and crispiness; manufacturing to test hardness and tactile qualities for materials, textiles, and/or consumer products; other animal fields such as ovine, caprine and swine to standardize behavioral assays of touch sensitivity in animal models; metallurgy and mining to assess ore density and karat of precious metals; and archeology and paleontology to determine fossil brittleness and tool preservation.

In the selection step 1310, an operator 1301 may begin by selecting an individual test subject 1302 that may require limb and hoof evaluation. This selection may be done at random or at the suggestion of the instrumented hoof tester 100, 600 based on the stored historical log files 1303. For example, the instrumented hoof tester 100, 600 may warn the operator 1301 via the alert module 1280 about specific test subjects 1302 that may need a follow up examination in light of past testing results stored in the storage module 1250 of the instrumented hoof tester 100, 600.

Once a specific test subject 1302 is determined for evaluation, the operator 1301 in the test subject identification step 1320 may scan the RFID tag 1304 of the test subject 1302 with the test subject identification module 1270 of the instrumented hoof tester 100, 600 in order to create a new log file 1303 for that specific test subject 1302. The log file 1303 may include the unique identification information for that test subject 1302, as well as logistical information such as the date, time and location of the testing procedures. The log file 1303 for that test subject 1302 may also be created manually by the operator 1301 inputting the information via the user module 1230. In addition, the new log file 1303 may be compiled with any historical data stored in the storage module 1250 associated with the specific test subject 1302.

In the hoof identification step 1330, the hoof identification module 1290 may initiate an automated means for determining which hoof is to be tested first by the operator 1301. For example, as detailed above, the instrumented hoof tester 100, 600 may have an automated set routine 1294 that prompts the operator 1301 through the procedures on which hoof to test. Alternatively, the operator 1301 may manually identify which hoof is being tested by switching a dial 1292 that indicates the particular hoof (e.g., fore-right (RF), fore-left (LF), hind-right (RH), hind-left (LH)). Specific hoof identification coupled with the individual test subject 1302 identification advantageously offers granular analysis and evaluation for more robust clinical evaluation.

In the testing step 1340, the operator 1301 may perform testing of the test subject 1302 with the instrumented hoof tester 100, 600 and start generating measurements by the measuring module 1260 to be processed, displayed and stored, among other functionalities. Each test or use (i.e., squeeze and release action by the operator 1301 on a test subject 1302) with the instrumented hoof tester 100, 600 may generate data for processing and/or analysis. An operator 1301 may prefer to perform multiple tests or uses on a single hoof in order to improve diagnostic accuracy of the clinical evaluation. Further, an operator 1301 may test multiple spots of the same hoof in order to pinpoint any potential problem areas. The instrumented hoof tester 100, 600 will collect all of the generated data and compile it together with the associated identification and technical information as part of the test subject's 1302 log file 1303.

Once testing is complete on that specific hoof, the operator 1301 may return to hoof identification step 1330 to switch the hoof identification module 1290 and indicate a different hoof will now be tested. An automated means for hoof identification may also be initiated at the start to accomplish the hoof identification step 1330. Once a new hoof is identified either manually or automatically, the operator 1301 may repeat the testing step 1340 on the next hoof. This process of repeating the hoof identification step 1330 and testing step 1340 may continue until all four hoof or limbs have been tested, or the operator manually terminates the testing procedures. For example, only one hoof may be tested during the follow up step 1390 to evaluate the effectiveness of past treatments. While not illustrated here, it may be contemplated that other fields of application may require more than four granular components for identification of a specific test subject 1302.

In the visualization step 1350, a capturing of visual data by a visualization member 1296 of the hoof identification module 1290 may be performed simultaneously during the collection of measurements by the measuring module 1260 performed during the testing step 1340. For example, the visualization member 1296 such as a LiDAR Scanner, video camera, photographic camera, radiographs, ultrasound and/or other similar optical recording means may capture a detailed view of the test subject 1302 under examination. The addition of visual data that corresponds to the measurements generated by the measuring module 1260 may beneficially provide alternative evidence to support the operator's 1301 evaluation and findings with the instrumented hoof tester 100, 600. All data collected by the instrumented hoof tester 100, 600 may be sent to the storage module 1250 for local storage as well as for remote storage 1256 via a network 1305 that connects the remote storage 1256 (e.g., cloud storage) to the instrumented hoof tester 100, 600 via the communications module 1240. The network 1305 and its connection to the digital instrumented tester 100, 600 may be established using any number of well-known wired (e.g., LAN) or wireless (e.g., Wifi, Bluetooth, LoRa, Cellular) networking capabilities. The remote storage 1256 of the collected data may provide a backup to the local storage with the removable storage 1252 and the internal storage 1254 on the instrumented hoof tester 100, 600, as well as may serve as an opportunity to compile all the data from multiple different instrumented hoof testers 100, 600, operators 1301 and test subjects 1302 from different locations over an extended period time (e.g., months, years) together for formulation of scoring protocols 1306.

The integrated networking capabilities provided, for example, via the network 1305 may enable pairing of the instrumented hoof tester 100, 600 with auxiliary devices 1307 and/or auxiliary instruments in the pairing step 1360. The network 1305 may leverage wired and/or wireless connections to provide flexible connectivity options for the pairing step 1360 as well as other steps such as the testing step 1340. By linking the instrumented hoof tester 100, 600 with auxiliary devices 1307 such as personal computers, electronic tablets, cellphones, printers and/or other similar computative devices and/or auxiliary instruments such as a keyboard and a mouse, expanded capabilities of the instrumented hoof tester 100, 600 may beneficially emerge. For example, auxiliary devices 1307 may offer supplemental display and/or visualization procedures while reducing integrated display and/or visualization requirements for the controller 1200. Auxiliary devices 1307 and/or auxiliary instruments may also provide secondary input, control and processing mechanisms, for example, leveraging a touchscreen functionality of a cellphone for an alternate user module for the operator 1301. Moreover, various mounting options may allow securing these auxiliary devices 1307 and/or auxiliary instruments physically to the instrumented hoof tester 100, 600 when beneficial. By way of example, the auxiliary device 1307 may be directly mounted to the instrumented hoof tester 100, 600 as illustrated here in the testing step 1340 and secured in any preferred orientation or location on the instrumented hoof tester 100, 600 in the same fashion as the various means for fastening the controller 230, 500, 680, 710 to the instrumented hoof tester 100, 600 as detailed above. The network 1305 supports interfacing with the controller 1200 of the instrumented hoof tester 100, 600 as well as with a with a range of auxiliary devices 1307 and/or auxiliary instruments to advantageously augment functionality and usability of the instrumented hoof tester 100, 600 with tailored system capabilities and ergonomics to meet demanding usage contexts and individual operators' 1301 needs.

In the alerting step 1370, a status 1308 of the test subject 1302 may be generated by the processing module 1210 based on the current measurements collected upon completion and/or termination of the testing step 1340. The generated status 1308 may also include data from the log files 1303 stored in the storage module 1250 as well as the identification and technical information particular to the test subject 1302. The generated status 1308 may format the collected data in raw and/or summarized format and may be displayed to the operator 1301 on the output terminal 1232 of the user module 1230 in a format suitable for the application of the instrumented hoof tester 100, 600. For example, in the field of clinical diagnosis for lameness in equine or bovine, the generated status 1308 may show the health of the test subject 1302 and create alerts highlighting areas of concern in the hoof of the test subject 1302 that may require treatment. Alerts, for example, in the form of indication 1282, an audio indication 1284, and/or tactical indication 1286 may also be generated independently and sent directly from the alert module 1280 of the instrumented hoof tester 100, 600 to the operator 1301. By way of example, an alert of the status 1308 may signal the operator 1301 during the testing step 1340 of erroneous overloading to prevent unnecessary pain to the test subject 1302 or damage to the instrumented hoof tester's 100, 600 components. The status 1308 and/or alert generation of the alerting step 1370 may also be performed by the auxiliary device 1307 paired with the instrumented hoof tester 100, 600 in order to verify the findings and/or streamline functionalities. Alternatively, the generated status 1308 may be sent to the auxiliary device 1307 in communication with the instrumented hoof tester 100, 600 via the network 1305.

As demonstrated in the review step 1380, the generated alerts and/or status 1308 may advantageously provide invaluable insights into the health and/or condition of the test subject 1302. In particular, the instrumented hoof tester's 100, 600 ability to correlate the collected measurements with scoring protocols 1306 based on industry lameness grading standards for exemplary applications such as equine, bovine, ovine, caprine and swine, may provide vital information into the health of the test subject 1302. In the review step 1380, the operator 1301 may make more informed decisions regarding the healthcare of the test subject 1302 and act to appropriately address and treat the discovered issues. The review step 1380 may also provide insights into the status 1308 of a test subject 1302 to better inform quality assurance practices in a variety of fields. Accordingly, an operator 1301 of the instrumented hoof tester 100, 600 may become immediately aware of pertinent issues that may require further investigation by an expert such as a veterinarian, a farrier or a hoof trimmer, as well as avoid costly unnecessary visits by experts where no issue is discovered by the instrumented hoof tester 100, 600. During the review step 1380, the operator 1301 may also input a user score 1309 that represents the operator's 1301 observations and opinion of the status 1308 of the test subject 1302. The user score 1309 may be correlated to the measurements generated by the measuring module 1260 to update the scoring protocols 1306 for a specific status 1309 and/or condition of the test subject 1302, as well as species and/or breed of test subjects 1302. In the follow up step 1390, the operator 1301 may perform a follow up visit repeating the detailed steps above in order to, for example, monitor the progression of the recovery or deterioration of the status 1308 and/or condition of the test subject 1302.

An exemplary advantage of such a general operation 1300 of the instrumented hoof tester 100, 600 and its novel system of use is the compilation of inputted and measured data over time and from various operators 1301, test subjects 1302 and/or instrumented hoof testers 100, 600 that may support development of a universal gold standard of scoring protocols 1306 for testing. By way of example and not limitation, current methodologies for examining lameness in bovine and equine have well established grading and scoring scales. Given the interconnected instrumented hoof tester system and methodologies established by the general operation 1300 of the instrumented hoof testers 100, 600 via the network 1305 and remote storage 1256, universal scoring protocols 1306 for a wide range of diagnosis and evaluation procedures may be developed to match industry standardized scoring scales specific to a certain field (e.g., 1-5 scale in bovine and/or 0-5 scale in equine) with the force measurements generated by the measuring module 1260 of the instrumented hoof tester 100, 600.

Any or all the data stored in the storage module 1250 may be utilized to employ statistical and mathematical techniques to formulate the scoring protocols 1306 that may guide the operation of the instrumented hoof tester 100, 600 as detailed above as well as define a true/false diagnosis (e.g., lame or sound given a measurements greater or less than 120 pounds), and/or the level of severity and/or type of issue discovered by the instrumented hoof tester 100, 600. For example, a 1-sound score may be greater than 120 pounds, a 2-mildly lame score may be between 80-120 pounds, a 3-moderately lame score may be between 60-80 pounds, a 4-lame score may be between 20-60 pounds, and a 5-severely lame score may be less than 20 pounds in bovine applications. To further assist with development of universal scoring protocols 1306 for the instrumented hoof tester 100, 600 for a particular application such as bovine lameness detection, an operator 1301 during the review step 1380 may also be able to input a user score 1309, which may also include additional information regarding the status 1308 of the test subject 1302 such as lesion type (e.g., white line disease, abscess, ulcer, etc.), based on the opinion of the operator 1301 such that the user score 1309 will be correlated and stored in the remote storage 1256 and local storage of the storage module 1250 with the other inputted and measured data associated with that specific test subject 1302. The formulated scoring protocols 1306 may not only be based on and/or updated by specific applications or species of test subjects 1302, but also may be based on and/or updated by other characteristics of the test subjects 1302 such as breed, gender, age, etc. in order to formulate individual and granular scoring protocols 1306 to employ for future reference. Accordingly, the instrumented hoof tester 100, 600 with its continuously updating functionalities is a powerful new tool, for example, to examine and evaluate lameness in equine, bovine, ovine, caprine and swine at an objective level, among other benefits, that will continue to evolve with changes to various industries' standards and practices.

Where a range of values is provided, it is understood that each intervening value, to the tenth of the unit of the lower limit unless the context clearly dictates otherwise, between the upper and lower limit of that range and any other stated or intervening value in that stated range, is encompassed within the invention. The upper and lower limits of these smaller ranges may independently be included in the smaller ranges and are also encompassed within the invention, subject to any specifically excluded limit in the stated range. Where the stated range includes one or both of the limits, ranges excluding either or both of those included limits are also included in the invention.

Various embodiments disclosed herein are described as including a particular feature, structure, or characteristic, but every aspect or embodiment may not necessarily include the particular feature, structure, or characteristic. Further, when a particular feature, structure, or characteristic is described in connection with an embodiment, it will be understood that such feature, structure, or characteristic may be included in connection with other embodiments, whether or not explicitly described. Thus, various changes and modifications may be made to the provided description without departing from the scope or spirit of the disclosure.

Other embodiments, uses and features of the present disclosure will be apparent to those skilled in the art from consideration of the specification and practice of the inventive concepts disclosed herein. The specification and drawings should be considered exemplary only.

1-19. (canceled)

20. An instrumented hoof tester, comprising:
a first arm having a first jaw and a first handle;
an second arm having an second jaw and a second handle;
an interlocking pin which interconnects the first arm and the second arm, wherein when the first arm and the second arm are connected by the interlocking pin the first jaw and second jaw are movable along an engagement path based on application of a user force component to the first handle and to the second handle, and wherein application of the user force component generates a translated force component applied to a test subject held between the first jaw and the second jaw on the engagement path; and
one or more force sensors secured to the first arm to measure the translated force component, wherein the movement of the first arm and the second arm deforms the first arm to bend each of the one or more force sensors by a respective deflection component, wherein the one or more force sensors provide for a measurement of the translated force component generated upon application of the user force component to the first handle and the second handle.

21. The instrumented hoof tester of claim 20, wherein the first arm is configured to be returnable to an original shape to tare the one or more force sensors upon release of the user force component applied to the first handle and the second handle.

22. The instrumented hoof tester of claim 20, wherein each of the one or more force sensors are secured to the first arm and conform to a shape and a geometry of the first arm.

23. The instrumented hoof tester of claim 22 wherein the first arm comprises a cavity to accommodate each of the one or more force sensors.

24. The instrumented hoof tester of claim 22 wherein the first arm comprises a wedge formed therein to accommodate each of the one or more force sensors.

25. The instrumented hoof tester of claim 20, wherein each of the one or more force sensors comprise a flexible backing supporting a foil wire arranged in a grid pattern to generate a resistance change, wherein movement of the first arm and the second arm deforms the first arm to bend the foil wire and generate the resistance change to permit measurement of the translated force component by the one or more force sensors.

26-28. (canceled)

29. The instrumented hoof tester of claim 20, wherein the one or more force sensors are each secured to the second arm, wherein movement of the first arm and the second arm deforms the second arm to bend each of the one or more force sensors by the respective deflection component upon the application of the user force component to the first handle and the second handle.

30-31. (canceled)

32. The instrumented hoof tester of claim 20, wherein the first arm and the second arm form an elastic member configured to be symmetrically deformable, wherein movement of the first arm and the second arm deforms the elastic member to bend each of the one or more force sensors by a respective deflection component and permit the one or more force sensors to measure the translated force component upon the application of the user force component to the first handle and the second handle.

33. The instrumented hoof tester of claim 20 further comprising:
a hollow tubing formed on or in the first arm to accommodate the one or more force sensors inside the hollow tubing.

34. The instrumented hoof tester of claim 33 further comprising:
an access cap fitted to the first jaw to provide entry into the hollow tubing, wherein the access cap is configured to be removable and re-attachable.

35. The instrumented hoof tester of claim 33 further comprising:
an access cap fitted to the first handle to provide entry into the hollow tubing, wherein the access cap is configured to be removable and re-attachable.

36. The instrumented hoof tester of claim 20, wherein each of the one or more force sensors is calibrated to correlate the respective deflection component to the translated force component.

37. The instrumented hoof tester of claim 36 further comprising:
a calibration block having a strain gauge to measure the translated force component and formulate a benchmark for the measured translated force component, wherein movement of the first arm and the second arm by application of the user force component to the first handle and to the second handle generates the translated force component applied to the calibration block held between the first jaw and the second jaw on the engagement path, wherein the benchmark is correlated to the respective deflection component and is used to calibrate each of the one or more force sensors.

38. The instrumented hoof tester of claim 20 further comprising:
a controller connected to the one or more force sensors, wherein the one or more force sensors are configured to provide the measured translated force component to be processed by the controller.

39. The instrumented hoof tester of claim 38 further comprising:
one or more fasteners to secure the controller to the first arm, wherein the controller is configured to be removable and reattachable by the one or more fasteners.

40. The instrumented hoof tester of claim 39, wherein the one or more fasteners each comprise a pair of mounting brackets affixed to the first arm to secure the controller to the first arm via a connection hub, wherein the pair of mounting brackets comprise a snap female end to fit a corresponding snap male end formed on a bottom of the connection hub, wherein the controller is removable and re-attachable via the pair of mounting brackets.

41. The instrumented hoof tester of claim 38, wherein the controller receives the measured translated force component to be processed, the controller comprising a processing module programmed to implement instructions to:
display one or more of the measured translated force component sent by the measuring module via the controller, and a status of a test subject subjected to the measured translated force component.

42. The instrumented hoof tester of claim 38, wherein the controller receives the measured translated force component to be processed, the controller comprising a processing module programmed to implement instructions to:
compare the measured translated force component to scoring protocols to determine a status of the test subject, and
signal the status of the test subject, wherein the status indicates a level of severity.

43. (canceled)

44. (canceled)

45. The instrumented hoof tester of claim 42, wherein the processing module is programmed to implement instructions to:
identify the test subject via the controller; and
create a log file that identifies the test subject and includes one or more of the measured translated force component and the determined status.

46. The instrumented hoof tester of claim 42, wherein the processing module is programmed to implement instructions to:
input a user score of the test subject via the controller;
correlate the inputted user score to the measured translated force component; and
update the scoring protocols for determining the status of the test subject.
